(19) United States
(12) Patent Application Publication
(10) Pub. No.: US 2011/0292428 A1
(43) Pub. Date: Dec. 1, 2011

(54) IMAGE PROCESSING DEVICE, DISPLAY DEVICE, SCREEN CONTROL SYSTEM, AND SCREEN CONTROL METHOD

(75) Inventor: Yuuichi ISHII, Tokyo (JP)

(73) Assignee: RICOH COMPANY, LTD., Tokyo (JP)

(21) Appl. No.: 13/113,440

(22) Filed: May 23, 2011

(30) Foreign Application Priority Data
May 27, 2010 (JP) NO.2010-121748

(51) Int. Cl. G06F 3/12

(52) U.S. Cl. 358/1.13

(57) ABSTRACT

An image processing device in which a plurality of applications each having multiple functions can be installed includes a display device and an application control unit. When screen definition information acquired from a first application includes definition information of a second application corresponding to a screen change destination, the application control unit displays an application screen in which a display component for selecting a function of the second application is arranged, on the display device. When an input manipulation on the application screen by a user is received, the application control unit specifies a function of the second application based on a result of determination of an event type of the received input manipulation and displays a functional screen of the specified function of the second application on the display device as a result of the operation of the screen change.

### BACKGROUND OF THE INVENTION

1. Field of the Invention

The present disclosure relates to an image processing device including a display device on which an operational screen is displayed using a software environment including various applications with functions that are installed therein.

2. Description of the Related Art

In recent years, in order to meet the increasing diversity in uses, an image processing device in which a plurality of applications are preinstalled has been introduced. The image processing device is designed to provide users with multiple functions including a copier function, a scanner function, a fax function, a printer function, etc. In this image processing device, a display device (operation panel) is provided so that an operational screen (application screen) for each application is displayed on the display device in order to offer convenience to users when using each of the multiple functions.

The above-described image processing device basically has a function of managing the applications and may have a function of managing the application screens. In particular, the image processing device may have a function of controlling screen changes between the application screens. For example, Japanese Laid-Open Patent Publication No. 2007-049677 discloses a system which integrally configures an application managing mechanism for managing applications mounted on an image processing device. The system enables a user to change an application screen to another screen through an application selection screen displayed on an operation panel by a screen manager in the system.

However, in the system according to the related art, there has been a problem that a number of operations are needed at a time of a screen change between application screens. For example, according to the related art, when a user desires to perform a fax function on the image processing device after a copier function is performed, the user changes a copy screen to the application selection screen, and, after the fax function is selected by using the application selection screen, the user has to change the application selection screen to a fax screen. Namely, according to the related art, the user cannot change the copy screen directly to the fax screen. Although it is preferable to the user to perform a single operation for selecting a desired function in the application selection screen, the user has to perform two operations (to display the application selection screen and to select the desired function) at the time of the screen change between the application screens according to the related art.

Furthermore, in recent years, some of the applications installed in the image processing device may provide two or more functions. In such a case, according to the related art, when a user desires to perform a function setting, the user selects a desired function from among the functions included in an application screen, and the user has to perform a screen change from the application screen to a functional screen and then perform the function setting by using the functional screen. Namely, the user needs to perform step-by-step operations according to the hierarchical configuration of the functions of the application.

Thus, according to the related art, the screen manipulations needed at the time of performing the process using the plural functions have been complicated for the user.

### SUMMARY OF THE INVENTION

In one aspect, the present disclosure provides an image processing device, a display device, a screen control system, and a screen control method which are capable of reducing the number of operations needed at the time of a screen change between the installed applications or between the functions of the installed applications and capable of reducing the complexity of the screen manipulations.

In an embodiment which solves or reduces one or more of the above-mentioned problems, the present disclosure provides an image processing device in which a plurality of applications each having multiple functions can be installed, the image processing device including: a display device; and an application control unit configured to control a displaying of an application screen or a functional screen on the display device and an operation of a screen change between the applications or between functions of the applications, wherein, when screen definition information acquired from a first application and defining an application screen of the first application includes definition information of a second application corresponding to a screen change destination, the application control unit displays an application screen in which a display component for selecting a function of the second application is arranged in a predetermined position, on the display device as the application screen of the first application, and wherein, when an input manipulation on the displayed application screen by a user is received, the application control unit specifies a function of the second application based on a result of determination of an event type of the received input manipulation and displays a functional screen of the specified function of the second application on the display device as a result of the operation of the screen change.

In an embodiment which solves or reduces one or more of the above-mentioned problems, the present disclosure provides a screen control method for use in an image processing device in which a plurality of applications each having multiple functions can be installed, the image processing device including a display device and an application control unit configured to control a displaying of an application screen or a functional screen on the display device and an operation of a screen change between the applications or between functions of the applications, the screen control method including: displaying, by the application control unit, when screen definition information acquired from a first application and defining an application screen of the first application includes definition information of a second application corresponding to a screen change destination, an application screen in which a display component for selecting a function of the second application is arranged in a predetermined position, on the display device as the application screen of the first application; specifying, by the application control unit, when an input manipulation on the displayed application screen by a user is received, a function of the second application based on a result of determination of an event type of the received input manipulation; and displaying, by the application control unit, a functional screen of the specified function of the second application on the display device as a result of the operation of the screen change.

Other objects, features and advantages of the present disclosure will become more apparent from the following detailed description when read in conjunction with the accompanying drawings.

### BRIEF DESCRIPTION OF THE DRAWINGS

FIG. 1 is a diagram showing the hardware composition of an image processing device of a first embodiment of the present disclosure.

FIG. 2 is a diagram showing the hardware composition of a display device (operation panel) in the image processing device of the first embodiment.

FIG. 3 is a diagram showing the software composition of the image processing device of the first embodiment.

FIG. 4A and FIG. 4B are diagrams for explaining a screen change operation according to the related art and a screen change operation according to the image processing device of the first embodiment.

FIG. 5 is a diagram showing the composition of a screen control function in the image processing device of the first embodiment.

FIG. 6A and FIG. 6B are diagrams showing examples of data of application information in the image processing device of the first embodiment.

FIGS. 7A, 7B, 7C and 7D are diagrams showing examples of data of screen definition information in the image processing device of the first embodiment.

FIGS. 8A, 8B and 8C are diagrams showing examples of data of screen definition information in the image processing device of the first embodiment.

FIG. 9 is a sequence diagram for explaining a process of screen control at a time of starting of the image processing device of the first embodiment.

FIG. 10 is a diagram showing an example of a screen change in the image processing device of the first embodiment.

FIG. 11 is a sequence diagram for explaining a process of screen control in the image processing device of the first embodiment.

FIG. 12 is a diagram showing an example of a screen change in the image processing device of the first embodiment.

FIG. 13 is a sequence diagram for explaining a process of screen control in the image processing device of the first embodiment.

FIG. 14A and FIG. 14B are diagrams showing examples of a starting screen in the image processing device of the first embodiment.

FIG. 15 is a sequence diagram for explaining a process of screen control at the time of starting of the image processing device of the first embodiment.

FIG. 16 is a diagram showing an example of a screen change in the image processing device of the first embodiment.

FIG. 17 is a sequence diagram for explaining a process of screen control in the image processing device of the first embodiment.

FIG. 18 is a diagram showing an example of a screen change in the image processing device of the first embodiment.

FIG. 19 is a sequence diagram for explaining a process of screen control in the image processing device of the first embodiment.

FIG. 20 is a diagram showing an example of a screen change in the image processing device of the first embodiment.

FIG. 21 is a sequence diagram for explaining a process of screen control in the image processing device of the first embodiment.

FIG. 22 is a sequence diagram for explaining a process of screen control in the image processing device of the first embodiment.

FIG. 23 is a sequence diagram for explaining a process of screen control in the image processing device of the first embodiment.

FIG. 24 is a diagram showing the composition of a screen control system of a second embodiment of the present disclosure.

FIG. 25 is a diagram showing the composition of a screen control function in the screen control system of the second embodiment.

FIG. 26 is a diagram showing the composition of a screen control function in the screen control system of the second embodiment.

### DETAILED DESCRIPTION OF THE PREFERRED EMBODIMENTS

A description will be given of embodiments of the present disclosure with reference to the accompanying drawings.

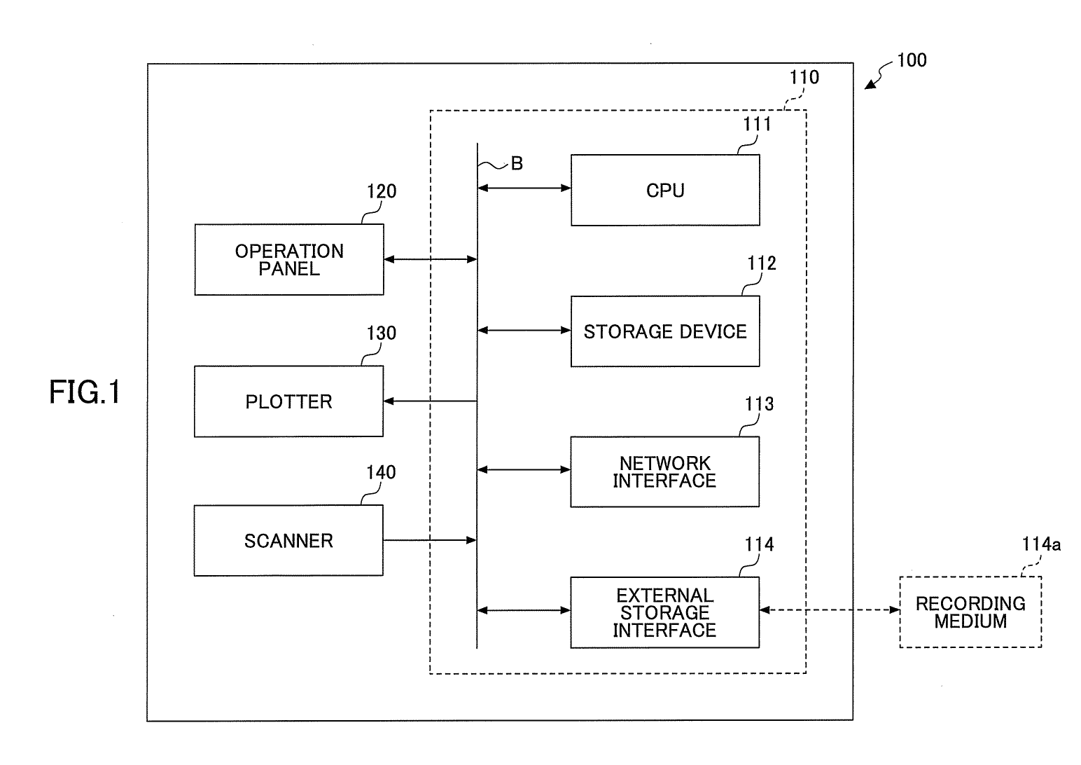

FIG. 1 is a diagram showing the hardware composition of an image processing device 100 of a first embodiment of the present disclosure.

As shown in FIG. 1, the image processing device 100 includes a controller 110, an operation panel 120, a plotter 130, a scanner 140, etc., and these elements are interconnected by a bus B.

The operation panel 120 includes a display unit and an input unit. The display unit provides a user with various information items, such as device information. The input unit receives from a user various operational control items, such as a setting of operation or an operational command.

The plotter 130 includes an image formation part and forms an output image on a recording sheet by using the image formation part. Examples of image formation methods used in the image formation part for forming an output image may include an electrophotographic printing method, an inkjet printing method, etc. The scanner 140 optically scans a document and generates a read image from the document.

The controller 110 includes a CPU (central processing unit) 111, a storage device 112, a network interface 113, an external storage interface 114, etc., and these elements are interconnected by the bus B. The CPU 111 controls the whole image processing device by executing a program. The storage device 112 stores the above-described program and various data (for example, image data). For example, the storage device 112 may include a ROM (read only memory) as a nonvolatile memory, a RAM (random access memory) as a volatile memory, a HDD (hard disk drive) including a mass storage area, etc. The RAM functions as a work area of the CPU 111 (a storage area to which the read program and data are temporarily loaded). The ROM and the HDD are used as a storage area in which the program or various data is stored. Hence, in the image processing device 100, the CPU 111 reads the program from the ROM, loads the read program to the RAM and executes the program on the RAM.

The network interface 113 is an interface for connecting the image processing device 100 to a predetermined data communication path or a network (for example, a LAN). The external storage interface 114 is an interface for connecting the image processing device 100 to a recording medium 114a which is an external storage unit. Examples of the recording medium 114a may include an SD (secure digital) memory card, a USB (universal serial bus) memory, etc. Hence, the image processing device 100 reads the program and data from the recording medium 114a through the external storage interface 114.

By using the above-described hardware composition, the image processing device 100 is capable of providing a user with the image-processing service (or the image processing function).

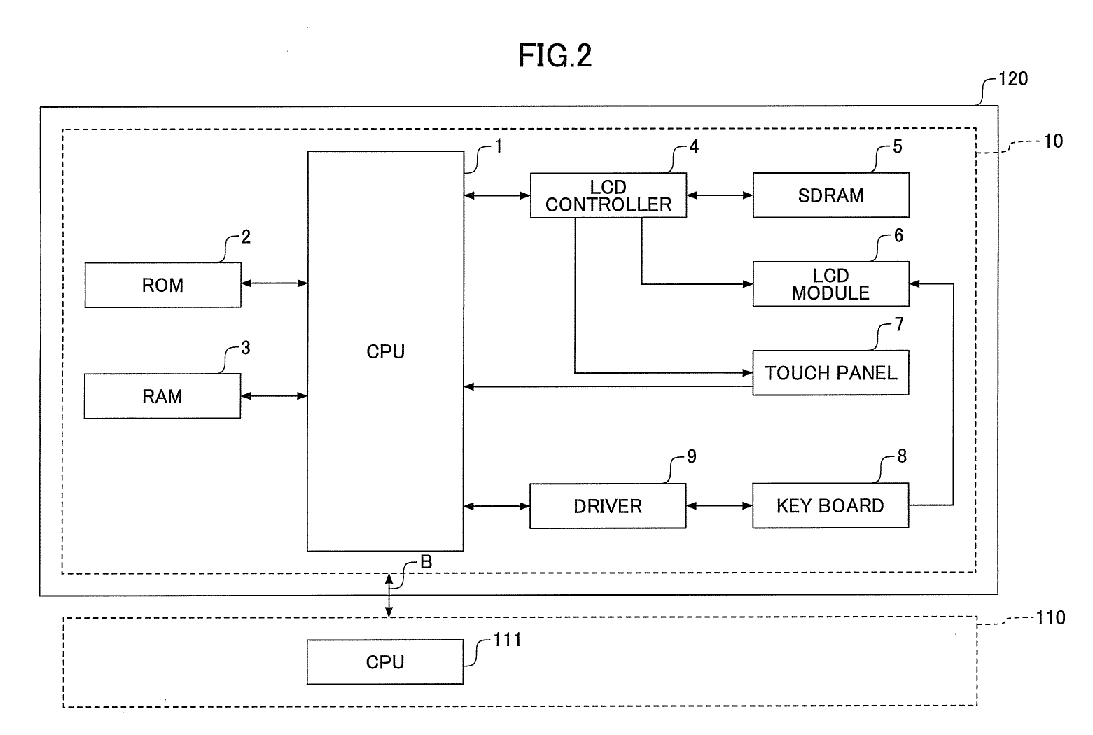

FIG. 2 is a diagram showing the hardware composition of a display device (operation panel) 120 in the image processing device of this embodiment. As shown in FIG. 2, the operation panel 120 includes a CPU 1 provided for exclusive use, and this CPU 1 is independent of the CPU 111 included in the controller 110 as a control board of the image processing device 100. The CPU 1 is mounted on a control board 10 of the operation panel 120. The control board 10 and the controller 110 are interconnected by a bus B, such as a synchronous serial bus, so that a variety of information items, including a display request from the image processing device and a key-in input from the operation panel, can be exchanged between the control board 10 and the controller 110. Hence, the operation panel 120 can display a variety of information items with respect to the image processing device 100, and the image processing device 100 can operate based on the information input from the operation panel 120.

A ROM 2 and a RAM 3 are connected to the CPU 1. The ROM 2 stores various programs related to display processes and input processes, and their associated data. The RAM 3 functions as a work area of the CPU 1. Furthermore, an LCD (liquid crystal display) controller 4 to control an LCD module 6, a touch panel 7 mounted in a display screen of the LCD module 6, and a driver 9 for a key board 8 are connected to the CPU 1. The CPU 1 reads out a program from the programs stored in the ROM 2, loads the program to the RAM 3, and executes the program on the RAM 3 to perform a corresponding one of the hardware controls which will be described In the following.

Namely, the CPU 1 performs a control of reading of data from an SDRAM (synchronous DRAM) 5 through the LCD controller 4 and performs a control of writing of data to the SDRAM 5 through the LCD controller 4. For example, the SDRAM 5 functions as a video RAM (VRAM) which stores the pixel data of an image to be displayed on the LCD module 6. The CPU 1 performs a backlight control of the LCD module 6 through the LCD controller 4. The CPU 1 performs a control of detection of depression of a key switch on the key board 8 (SW) through the driver 9, and performs a lighting control of an LED (light emitting diode) through the driver 9.

The LCD controller 4 performs a refreshing process of the SDRAM 5 and performs transmission of display data from the SDRAM 5 to the LCD module 6 (display signal outputting). The LCD controller 4 controls the outputting of a display signal in accordance with the setting of internal registers. The LCD controller 4 has a touch-panel interface function. When the touch panel 7 is depressed by a user, the LCD controller 4 outputs an interrupt signal to the CPU 1.

In the operation panel 120 which has the above-described hardware composition, an information handling service including an information displaying service and an information inputting service (inputting/outputting of information) can be provided to the user.

Similar to the controller 110, the control board 10 includes an external storage interface (not illustrated). Thereby, the operation panel 120 can access an external recording medium through the external storage interface.

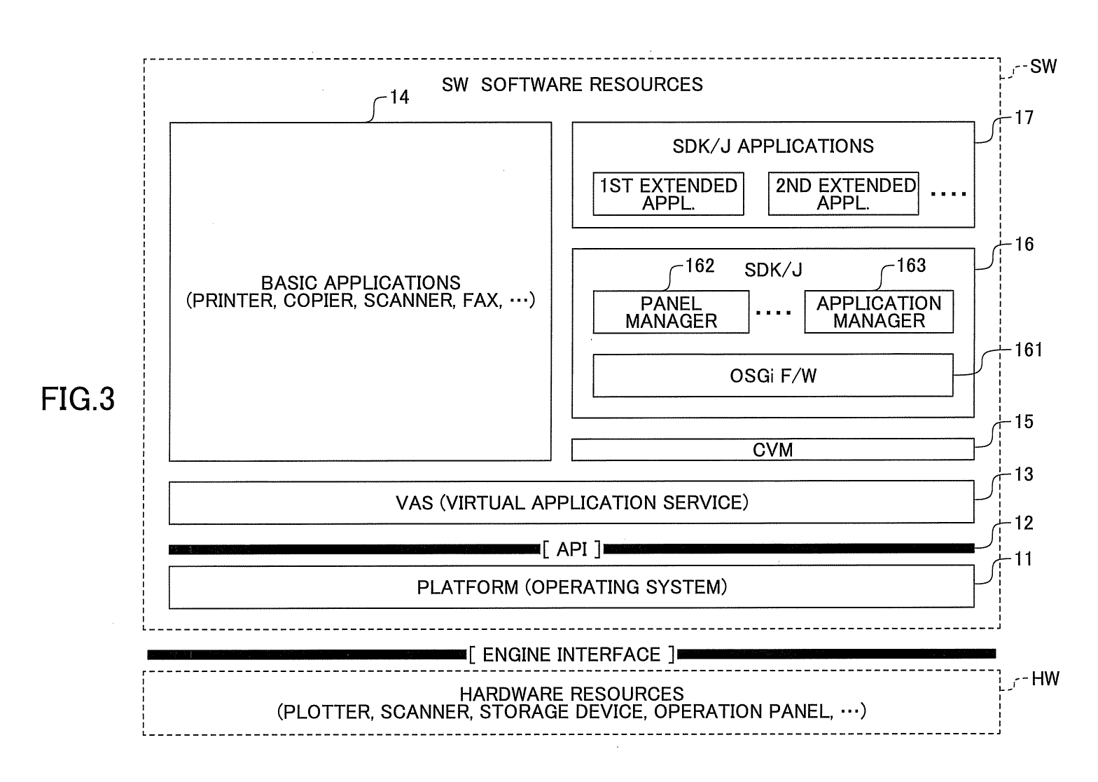

FIG. 3 is a diagram showing the software composition of the image processing device 100 of this embodiment. As shown in FIG. 3, the image processing device 100 includes a group of software resources which are constituted by a platform 11, a VAS (virtual application service) 13, an SDK/J (software development kit of Java) 16, basic applications 14, SDK/J applications 17, etc.

The platform 11 is a versatile embedded OS (operating system) which is configured to control the entire image processing device. For example, the platform 11 may be an embedded operating system, such as FreeBSD, Linux, etc. By using the engine interface, the platform 11 sends a command for executing an operation to any of the hardware resources of the image processing device (including a plotter, a scanner, a storage device, an operation panel, etc.) and receives a result of the operation from a corresponding one of the hardware resources. An application program running on the platform 11 transmits a request for execution of operation of a function of any of the hardware resources of the image processing device through an API (application programming interface) 12 and acquires a result of the operation of a corresponding one of the hardware resources through the API 12.

The VAS 13 is a virtual application service which is an application program that operates as a proxy unit between the platform 11 and the applications 14 and 17. The VAS 13 operates as a client process when the platform 11 operates as a server, while the VAS 12 operates as a server process when any of the applications 14 and 17 operates as a client. The VAS 13 has a wrapping function for having the platform 11 concealed from the applications 14 and 17, and plays a role in absorbing the difference between the current-version platform module and the following-version platform module after upgrading of the current-version platform module.

A CVM (C virtual machine) 15 is a Java virtual machine designed for higher-end consumer electronic and embedded devices. The CVM 15 provides an environment for execution of the SDK/J applications 17 that are written in the Java programming language. The SDK/J 16 provides an environment for development of the SDK/J applications 17. The SDK/J 16 includes an OSGi F/W (Open Service Gateway initiative framework) 161, a panel manager 162, and an application manager 163.

The OSGi F/W 161 is a module system and service platform for the Java programming language that implements a complete and dynamic component model. The applications or components (in the form of bundles for deployment) can be remotely installed, started, stopped, updated and uninstalled without requiring a reboot. In a device in which the OSGi F/W 161 is installed, application programs of the Java programming language are installed in the form of bundles. Functions of the device can be constituted by the bundles installed therein, and updating, customizing and maintenance of the functions of the device can be done by downloading of the bundles.

The panel manager 162 is a program that controls the operation panel 120 provided in the image processing device 100. The application manager 163 is a program that controls the SDK/J applications 17.

Each of the applications 14 and 17 is a program that operates on the image processing device and performs one of the various functions of the image processing device 100. Each of the basic applications 14 is a program that performs one of the basic functions of the image processing device 100 (including a copier function, a printer function, a scanner function, a fax function, etc.). On the other hand, each of the SDK/J applications 17 is a program that performs one of the extended functions of the image processing device 100, and this program is an SDK/J application (which will be called an extended application) which is developed on the SDK/J 16. For example, some extended applications 17 may be provided by software vendors (third-party vendors) other than the manufacturer of the image processing device 100. As mentioned above, if a software vendor has the SDK/J 16 provided as the development environment, the software vendor is able to carry out development and supplying of the extended application 17.

It is supposed that the extended application 17 in the image processing device 100 of this embodiment has a plurality of functions, and a screen control function to control an operation of a screen change between such extended applications or between the functions of the extended applications 17 is performed by the application manager 163 (screen control).

The screen control function of this embodiment will be described.

In the image processing device 100 of this embodiment, the application manager 163 (application control unit) to control the installed extended application 17 acquires, at the time of starting of the image processing device, the screen definition information and the extended application screen (ownership application screen) from the extended application 17 which is a default ownership application. When the definition information of the extended application 17 other than the default ownership application (the other extended application 17) is included in the acquired screen definition information, the application manager 163 acquires the extended application/function selection components (GUI parts: Graphical User Interface parts) from the other extended application 17 based on the composition function of the application information registered at the time of installation of the extended applications. The application manager 163 generates the display screen at the time of starting (starting screen) by arranging the acquired extended application/function selection components on the previously acquired ownership application screen. As a result, in the image processing device 100, the generated screen is displayed as the starting screen.

After starting of the image processing device 100, the image processing device 100 causes the extended application 17 (which is the current ownership application) to determine the event type received from the user. The application manager 163 specifies the function of the extended application 17 of the screen change destination based on the judgment result received from the extended application 17.

The application manager 163 specifies the function of the extended application 17 of the screen change destination, requests generation of a function screen, and acquires the generated functional screen (changed screen). As a result, in the image processing device 100, it is supposed that the present display screen is not displayed, and the acquired screen is displayed as the changed screen. The image processing device 100 has the above-described screen control function.

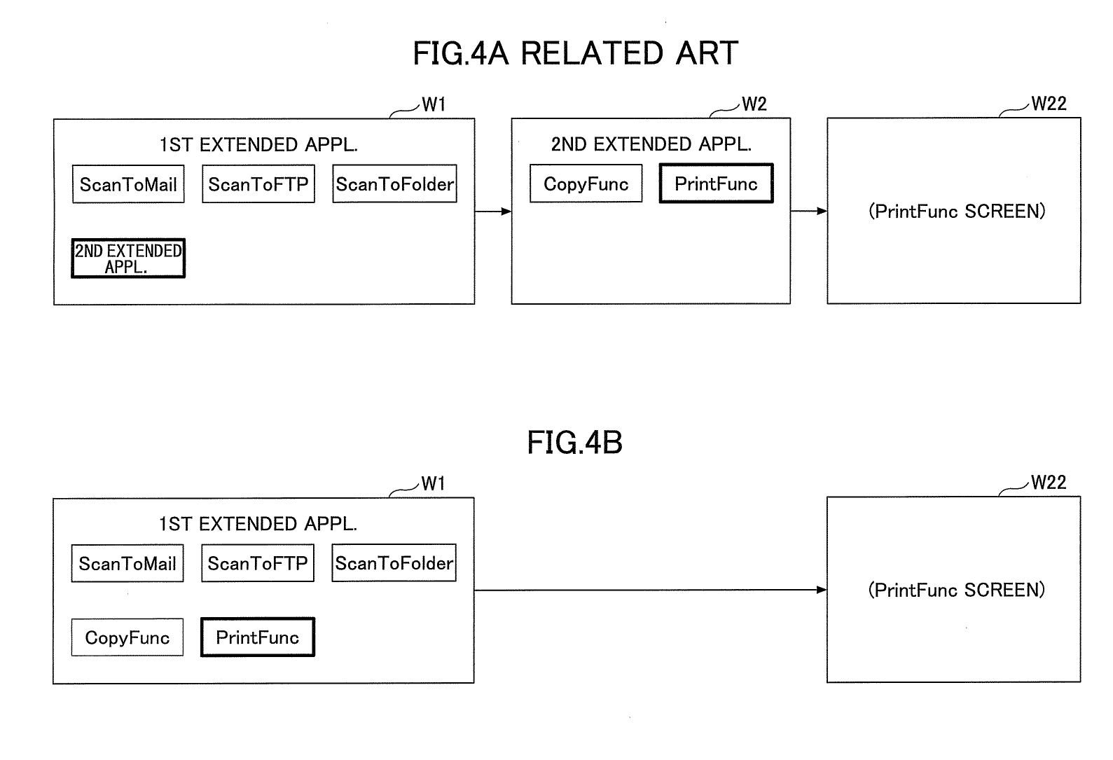

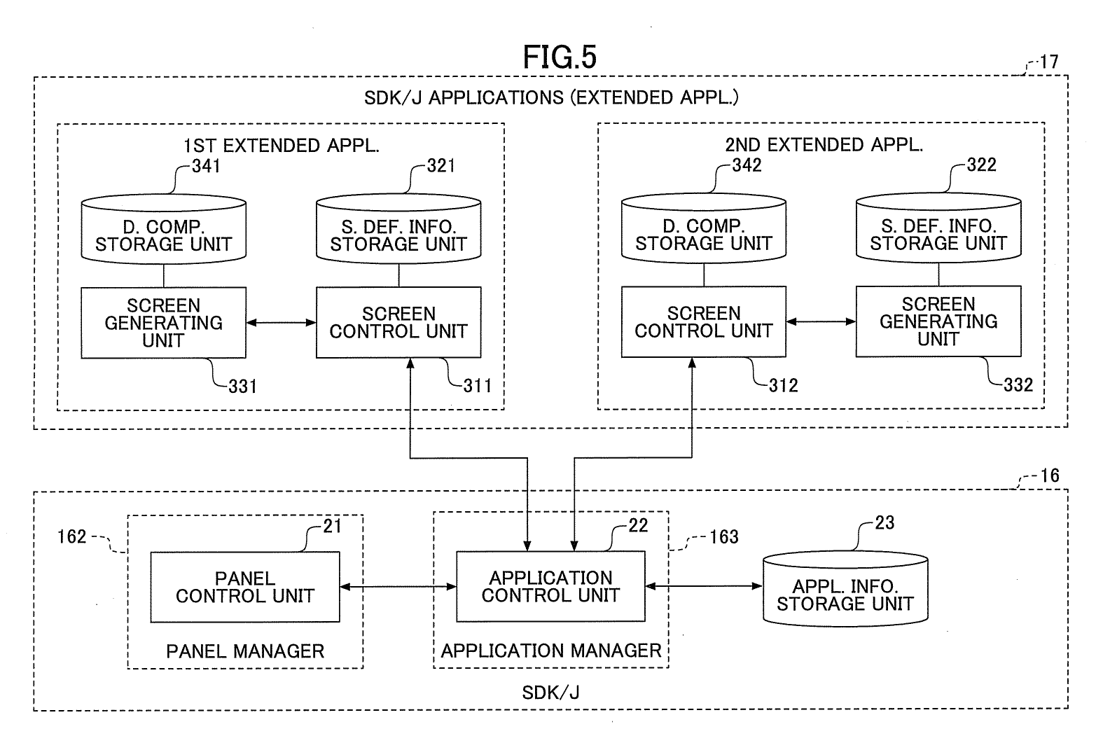

FIG. 4A is a diagram for explaining an example of a screen change operation according to the related art. FIG. 4B is a diagram for explaining an example of a screen change operation according to the image processing device of the first embodiment.

As shown in FIG. 4A, according to the related art, when a user desires to use a print function of the second extended application, an operational screen change as follows.

First, in an operational screen W1 (in the following, an extended application screen) of the first extended application that is the default ownership application (starting application), the selection button of the second extended application is depressed and an operation of a screen change is performed to the extended application screen W2 of the second extended application.

Subsequently, the selection button of the PrintFunc function in the extended application screen W2 of the second extended application is depressed, and an operation of a screen change is performed to the operational screen W22 (functional screen) of the PrintFunc function.

Namely, according to the related art, the operation of the screen change is performed through the extended application screen of the extended application 17 to which the optional feature belongs. Therefore, according to the related art, when a user performs a process using a plurality of functions, the number of operations needed at the time of the screen change remarkably increases and the screen manipulations needed become complicated.

To eliminate the problem, the image processing device 100 of this embodiment is arranged so that, at the time of starting of the image processing device, an operational screen W1 from which a plurality of functions of an extended application 17 can be selected at once is displayed, and, after the starting, an operation of a screen change between a plurality of functions of different extended applications 17 is performed.

With reference to FIG. 4B, an example of a screen change according to the image processing device of this embodiment will be described. For example, when it is desired to use a PrintFunc function of the second extended application, the operational screen according to the image processing device of this embodiment enables an operation of a screen change from the extended application screen W1 of the first extended application directly to a PrintFunc screen W22. Thereby, in the image processing device 100 of this embodiment, the number of operations needed at the time of a screen change between the installed applications or between the functions of the installed applications is reduced, and the complexity of screen manipulations can be reduced.

Next, the composition and the operation of the above-mentioned screen control function will be described.

FIG. 5 is a diagram showing the composition of the screen control function in the image processing device of this embodiment. As shown in FIG. 5, the screen control function is constituted by the panel control unit 21, the application control unit 22, the screen control unit 31, and the screen generating unit 32.

The panel control unit 21 is a function part of the panel manager 162. The application control unit 22 is a function part of the application manager 163. Namely, these function parts operate in the environment in which the SDK/J 16 operates. On the other hand, the screen control unit 31 and the screen generating unit 32 are function parts of each of the extended applications 17. Namely, these function parts function in the environment in which each extended application 17 operates.

In the composition shown in FIG. 5, the first extended application includes the screen control unit 311 and the screen generating unit 321, and the second extended application includes the screen control unit 312 and the screen generating unit 322. When the function parts in the extended application 17 are collectively referred to, they will be called the screen control unit 31 and the screen generating unit 32.

The panel control unit 21 is a function part which controls the operation panel (display device) 120 provided in the image processing device 100. The panel control unit 21 controls screen displaying and non-displaying of the operation panel 120. The panel control unit 21 receives input information from the operation panel 120. The input information includes event information which is received when the GUI, the hard key, etc. of the operation panel 120 is depressed.

The application control unit 22 is a function part which controls the extended application 17 of the image processing device 100. The application control unit 22 performs operation control, such as starting, stopping, terminating, etc. of the extended application 17. For example, the application control unit 22 sends a screen generating request of the extended application 17, and performs an operation of a screen change.

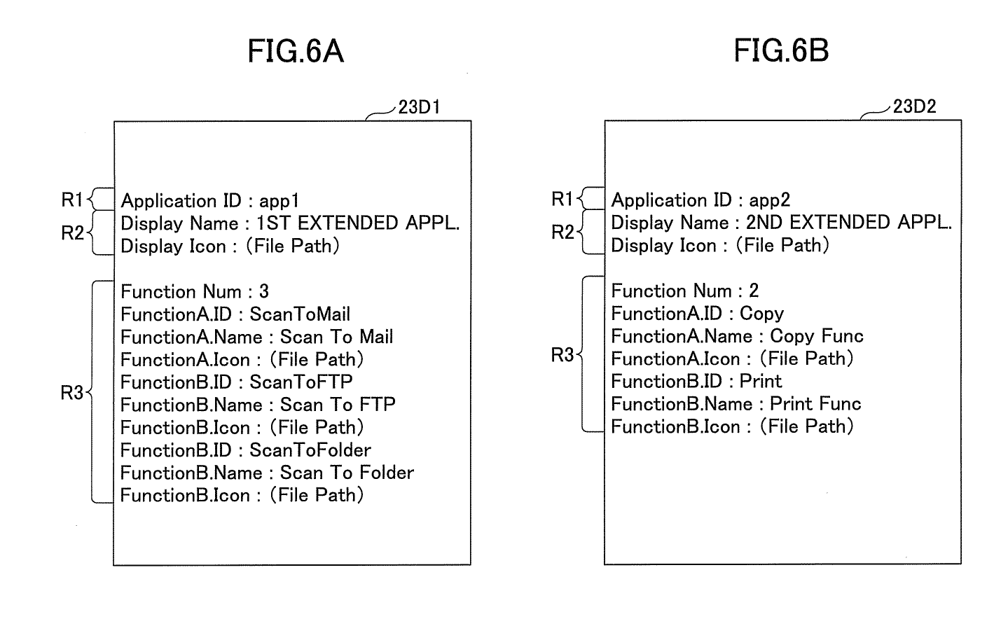

For example, in the application control unit 22, various operational control processes are performed based on the application information 23D as shown in FIG. 6A and FIG. 6B. FIG. 6A and FIG. 6B are diagrams showing examples of data of the application information 23D of this embodiment.

The example of data of the application information 23D1 corresponding to the first extended application is shown in FIG. 6A, and the example of data of the application information 23D2 corresponding to the second extended application is shown in FIG. 65. In the following, the application information 23D1 and the application information 23D2 are collectively called the application information 23D.

As shown in FIG. 6A or FIG. 6B, the application information 23D includes application identification information R1, display information R2, composition function data R3, etc. In the application information 23D, the display information R2, the composition function data R3, etc. are associated with the application identification information R1.

The application identification information R1 is information to identify the extended application 17. The application identification information R1 contains, for example, an application ID or the like. The display information R2 is information related to screen displaying of the extended application 17, and contains application name information, application selection component storage address information (display component storage address information), etc. The application name information is information which indicates the name of the extended application 17, and contains, for example, an application name or the like. The application selection component storage address information is information which indicates the storage address of the parts which select extended application 17, for example, there is a file path, etc.

The composition function data R3 is information related to a plurality of functions (functions which constitute the extended application) of the extended application 17, and contains the number of functions, functional identification information, function name information, function selection component storage address information (display component storage address information), etc. The number of functions is information which indicates the number of the functions of the extended application 17. The functional identification information is information which identifies a function, for example, a function ID. The function name information is information which indicates the name of a function, for example, a function name. The function selection component storage address information is information which indicates the storage address of the display component for selecting the function, for example, a file path.

When the extended application 17 is installed, the application information 23D is stored in the application information storage unit 23 and registered. Namely, the application information 23D is registered for each extended application 17. The application information storage unit 23 corresponds to a predetermined storage area of the storage device (for example, a HDD) provided in the image processing device 100.

Referring back to FIG. 5, the application control unit 22 operates as follows. The application control unit 22 sends a screen generating request to the extended application 17. The application control unit 22 accesses the application information storage unit 23, and acquires the display information R2 and the composition function data R3 corresponding to the extended application 17 based on the application identification information R1. The application control unit 22 sends to the extended application 17 the application identification information (functional identification information), the display component storage address information, etc., and requests generation of an extended application screen (functional screen). As a result, the generated screen from the extended application 17 of the request destination is received at the application control unit 22 (the generated screen is acquired).

The application control unit 22 operates as follows and performs the screen change control. The application control unit 22 sends the event information received through the panel control unit 21 to the extended application 17 (which is called an ownership application) which has the ownership (the right to display the screen), and requests the judgment of an event type. As a result, the determined result from the extended application 17 of the request destination is received at the application control unit 21 (the determined result is acquired).

When the result determined as being a screen change event is received, the application control unit 21 requests screen generation of the extended application 17 of the screen change destination based on the application identification information (functional identification information) received from the extended application 17 at the time of receiving, by the above-mentioned screen generating request method. As a result, the generated screen from the extended application 17 of the request destination is received at the application control unit 22 (the generated screen is acquired). Namely, the application control unit 22 specifies the extended application 17 (or the function of the extended application) corresponding to the screen change destination from the extended application 17 based on the application identification information (functional identification information) received as the determined result of the event type.

The application control unit 22 operates as follows, and performs the starting screen generation of the image processing device 100.

The application control unit 22 accesses the application information storage unit 23, and acquires the application information 23D corresponding to the extended application 17 (which is called a default ownership application) which has the default ownership (the right to display a screen at the time of starting). The application control unit 22 requests generation of an extended application screen of the default ownership application (which screen will be called ownership application screen) based on the acquired application information 23D by the screen generating request method. As a result, the generated screen (ownership application screen) from the default ownership application of the request destination is received at the application control unit 22 (the generated screen is acquired). At this time, the information from the default ownership application (which will be called screen definition information) in which the content of a display of the extended application screen, the event processing, etc. are defined is received at the application control unit 22 (the screen definition information is acquired).

The application control unit 22 determines whether the definition information of a different extended application 17 than the default ownership application (which will be called another extended application) is included in the screen definition information received from the default ownership application. When it is determined that the definition information of the other extended application 17 is included, the application control unit 22 acquires an applicable display component (an application selection component and function selection components) from the other extended application 17 based on the display component storage address information of the application information 23D (storage address information of an application selection component or function selection component). The application control unit 22 generates a starting screen by arranging the acquired display component on the ownership application screen acquired previously.

The application control unit 22 sends the acquired screen to the panel control unit 21 and requests the panel control unit 21 to display the screen. At this time, the application control unit 22 sets the ownership to the extended application 17 which displays the screen. When a screen update is requested from the application control unit 22, the panel control unit 21 sets the non-displaying of the screen having lost the ownership and displays the received screen having the ownership.

The screen control unit 31 is a function part which controls the extended application screen. The screen control unit 31 performs operation control, such as screen generation of the extended application 17 and an event-type determination.

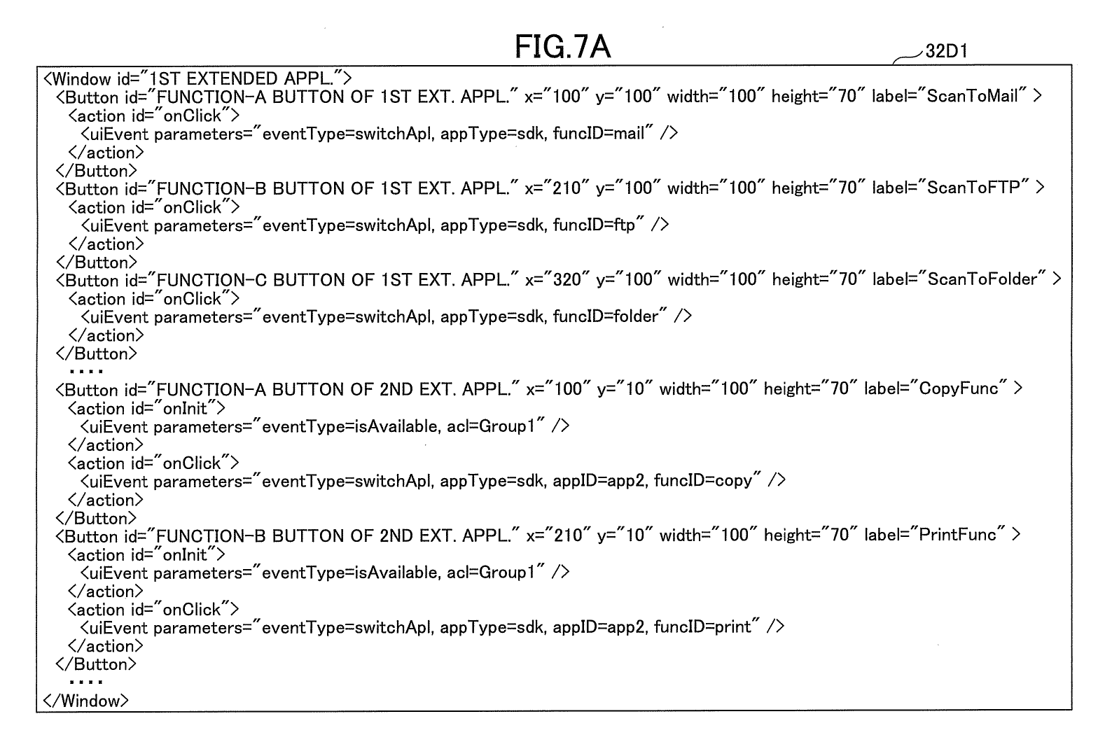

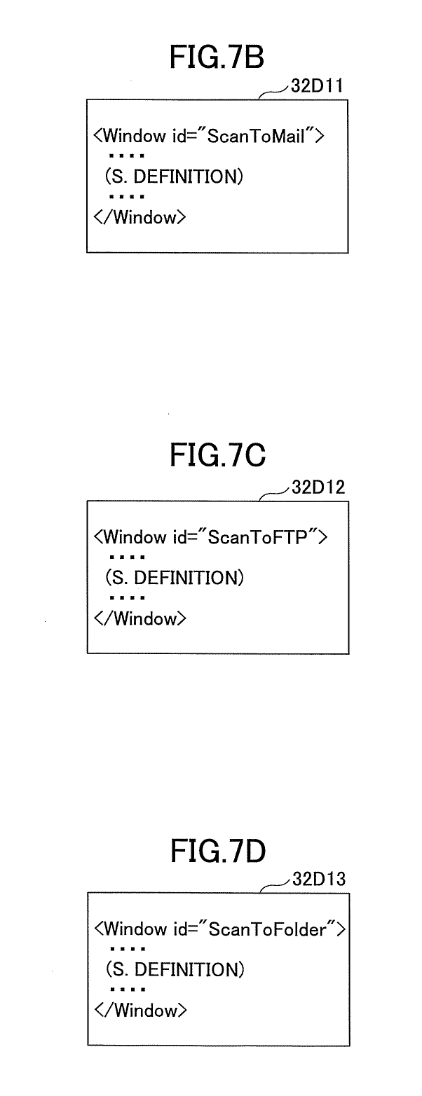

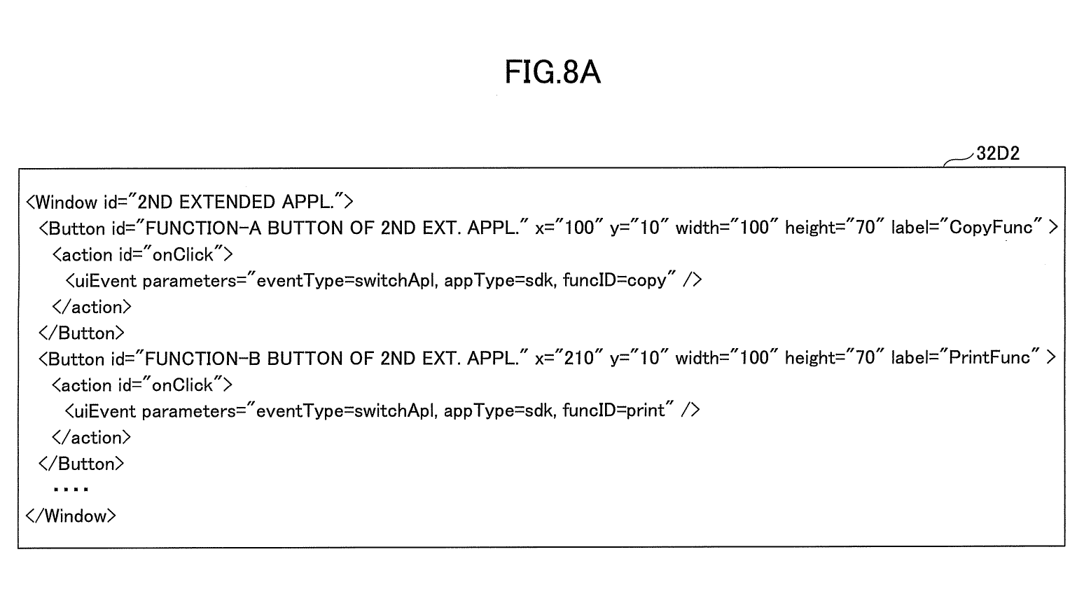

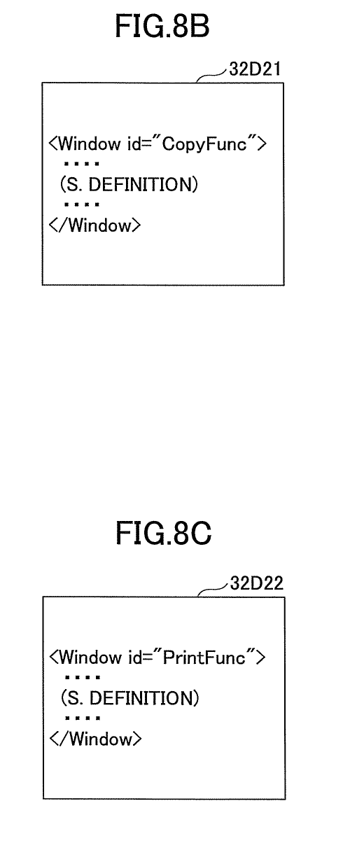

The screen control unit 31 performs various operation control based on the screen definition information 320 set up for the extended application 17 as shown in FIGS. 7A-7D and FIGS. 8A-8C.

FIGS. 7A-7D and FIGS. 8A-8C are diagrams showing examples of data of the screen definition information 32D1 and 32D2 of this embodiment. The examples of data of the screen definition information 32D1 corresponding to the first extended application are shown in FIGS. 7A-7D, and the examples of data of the screen definition information 32D2 corresponding to the second extended application are shown in FIGS. 8A-8C. The screen definition information 3201 and the screen definition information 3202 may be collectively called screen definition information 32D.

As shown in FIGS. 7A-7D and FIGS. 8A-8C, the content of a display, event processing, etc. of the extended application screen are defined as the screen definition information 32D according to the predetermined data format. Examples of data of XML (Extensible Markup Language) form are shown in FIGS. 7A-7D and FIGS. 8A-8C, and the variety of information for the screen definition information 32D is defined by the tags. In this embodiment, the tags, such as XML, are used for the screen information definition in order to define a plurality of information items in a hierarchical format with ease.

For example, a plurality of selection buttons (display components) are defined for the screen definition information 320 of this embodiment by the Button tags in the Window tags which define the extended application screen. In each Button tag, the event processing at the time of a selection button depression is defined by the action tag. Event information is defined by the uiEvent tag in each action tag.

Each tag has an attribute value. For example, the Window tag has an attribute value (id value) by which application identification information or functional identification information can be set up. The Button tag has an attribute value (id value, x, y values, width, height values) in which selection component identification information, the arrangement coordinates of a selection component, the size of a selection component, etc. can be set up. The action tag has an attribute value (id value) in which the information which identifies the issued event (event identification information) can be set up. The uiEvent tag has an attribute value (parameter values: eventType value, appType value, and appiD value (/funcID value)) in which event-type information, application kind information which indicates the kind of the application corresponding to the screen change destination, and identification information of the application corresponding to the screen change destination (identification information of a screen change destination function) can be set Up.

The screen definition information 32D is generated when a user sets up the tag data and the respective attribute values through a predetermined screen control tool.

When the extended application 17 is installed, the screen definition information 32D is stored and registered in the screen definition information storage unit 32. Namely, the screen definition information 32D is registered for each extended application 17 similar to the application information 23D.

The screen definition information storage unit 32 corresponds to a predetermined storage area of the storage device (for example, a HDD) provided in the image processing device 100. Moreover, three screen definition information items 32D11, 32D12, and 32D13 corresponding to the functional screens of the functions (ScanToMail, ScanToFTP, ScanToFolder) of the first extended application are shown in FIGS. 7B-7D. Two screen definition information items 32D21 and 32D22 corresponding to the functional screens of the functions (CopyFunc, PrintFunc) of the second extended application are shown in FIGS. 8B-8C. In this manner, the screen definition information 320 is may be registered on the basis of the functional processing module of the extended application 17.

Even the already registered screen definition information 32D may be edited or updated by using a predetermined tool. Thereby, a user may customize the application screen after installation of the extended application. The screen definition information 32D may be updated through the external storage interface 114 in which the data stored in the recording medium 114a is read and the read data is overwritten to the data of the screen definition information storage unit 32.

Referring back to FIG. 5, the screen control unit 31 specifies the applicable screen definition information 320 by accessing the attribute value of the Window tag of the screen definition information 320 stored in the screen definition information storage unit 32 based on the received application identification information (functional identification information) if the screen generating request is received. Namely, the screen control unit 31 specifies the extended application 17 (function) by which the screen generating request is carried out. The screen control unit 31 sends the specified screen definition information 320 and the selection component storage address information received to the request to the screen generating unit 33, and requests screen generation. As a result, the screen control unit 31 answers the generated screen to the screen generating request source.

The screen control unit 31 specifies the applicable Button tag data by accessing the attribute value of the Button tag of the screen definition information 320 stored in the screen definition information storage unit 32 based on the received event information (selection component identification information), if the event-type determination request is received. The screen control unit 31 determines whether the identification information “onClick” of the selection button depression event is set as the attribute value by accessing the attribute value of the action tag defined in the specified Button tag.

The screen control unit 31 determines whether the kind information “switchApl” of the screen change event is set as the attribute value by accessing the attribute value of the uiEvent tag defined in the action tag, when it is determined that the event identification information at the time of a selection button depression is set up.

The screen change destination set as other corresponding attribute values when the screen control unit 31 has checked that the event-type information on a screen change is set up the identification information of the application (identification information of a screen change destination function) is acquired.

The screen control unit 31 answers to the event-type determination requesting unit the acquired application identification information (functional identification information) as the determined result. The screen generating unit 33 is a function part which generates a screen by generating an extended application screen using the display component.

When the screen generating request is received by the template (framework) of the display screen received when requested, the screen generating unit 33 arranges the display component on the screen in accordance with the content of a display of the screen definition information 32D (arrangement coordinates and size), and generates an extended application screen. At this time, the screen generating unit 33 accesses the display component storage unit 34, and acquires the applicable display component based on the display component storage address information. The display component storage unit 34 corresponds to a predetermined storage area of the storage device (for example, an HDD) provided in the image processing device 100.

When the extended application 17 is installed, the display component is stored and registered in the display component storage unit 34. Namely, a display component is registered for each extended application 17 similar to the screen definition information 32D. The display component may be added or deleted according to the renewal of the screen definition information 32D.

Next, the operation (coordinated operation of function parts) of the screen control function of this embodiment will be described.

The screen control function of this embodiment is carried out by reading the program (software which performs the screen control function) installed in the image processing device 100 by the processing unit (for example, a CPU) from the storage address (for example, a ROM, a HDD, etc.), and loaded on the memory (for example, a RAM), and executing the following process by the processing unit in accordance with the program. The operation of a screen change in the process of the screen control will be described.

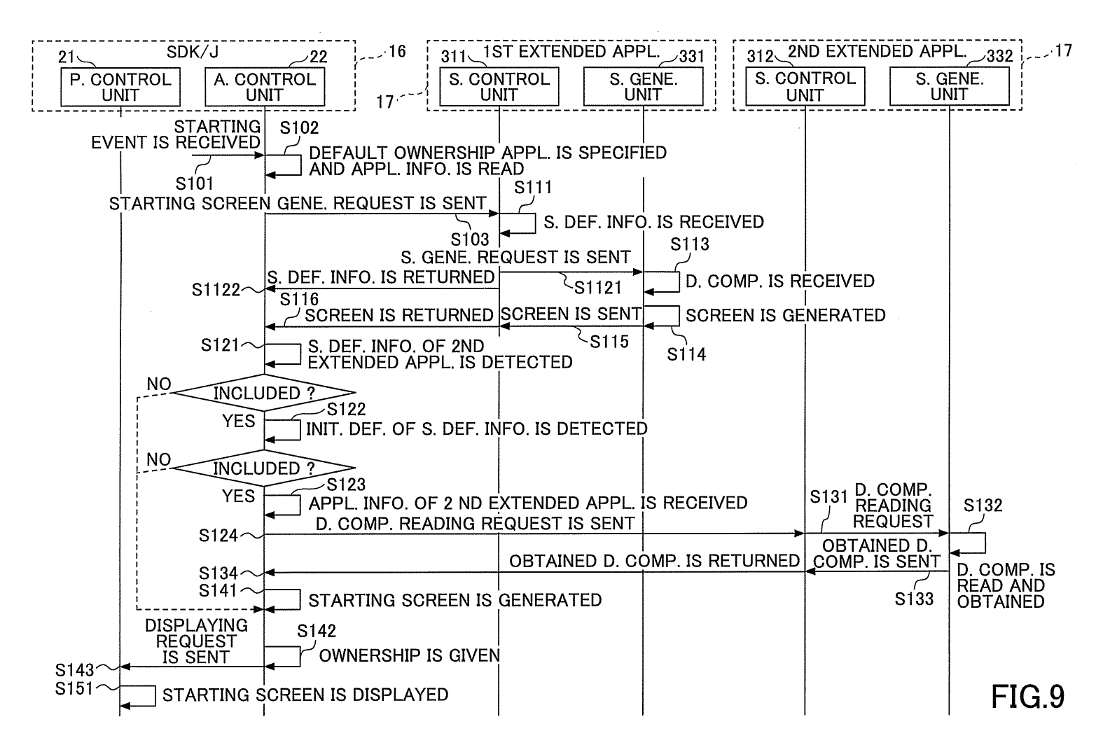

FIG. 9 is a sequence diagram for explaining a process of screen control at a time of starting of the image processing device of this embodiment.

In the image processing device 100, the extended application screen W1 shown in FIG. 4B is displayed as a starting screen by the process as shown in FIG. 9. When the image processing device 100 is started and the SDK/J 16 receives a starting event, as shown in FIG. 9 (step S101), the application control unit 22 specifies the default ownership application and acquires the application information 23D of the specified extended application (step S102).

The application control unit 22 specifies the extended application 17 which is the default ownership application based on the identification information (application identification information) of the default starting application set up beforehand. The process performed when the first extended application is set up as the default starting application is shown in FIG. 9.

The application control unit 22 accesses the application information storage unit 23, and acquires the corresponding application information 23D1 (default ownership application information of the first extended application specified) based on the application identification information.

The application control unit 22 requests generation of a starting screen of the first extended application that is the specified default ownership application (step S103). At this time, the application control unit 22 sends the application identification information, the display component storage address information of the acquired application information 2301, etc. to the first extended application. The application control unit 22 also sends the screen base data (framework/template data) to the first extended application.

By the screen control unit 311, the first extended application accesses the screen definition information storage unit 321, and acquires the corresponding screen definition information 3201 based on the application identification information received at the time of the starting screen generating request (step S111).

The screen control unit 311 sends a screen generating request to the screen generating unit 331 of the first extended application (step S1121). At this time, the screen control unit 311 sends the acquired screen definition information 32D1, the screen base data, and the display component storage address information, received at the time of the starting screen generating request, to the screen generating unit 331. The screen control unit 311 sends, to the application control unit 22, the screen definition information 32D1 at the time of the starting screen generating request (step S1122).

The screen generating unit 331 accesses the display component storage unit 341, and acquires the corresponding display component (function selection component of the first extended application) based on the display component storage address information received at the time of the screen generating request (step S113). The screen generating unit 331 forms and arranges the acquired display component according to the screen definition information 32D1 received at the time of the screen generating request, and generates a screen based on the screen base data (step S114). The screen generating unit 331 sends the generated screen to the screen control unit 311 (step S115).

The screen control unit 311 answers the generated screen received as the generated result to the application control unit 22 of the starting screen generating request source (step S116).

The application control unit 22 determines whether definition information of the second extended application that is another extended application 17 (default ownership application extended application) is included in the screen definition information 3201 of the first extended application (default ownership application) acquired from the screen control unit 311 (step S121). For example, the application control unit 22 determines existence of the definition information of the second extended application depending on whether the identification information app2 of the second extended application is set as the attribute value (appiD value) of the uiEvent tag defined as in the screen definition information 3201.

As a result, when existence of the definition information is determined, the application control unit 22 specifies the definition information of the second extended application within the screen definition information according to the data format (the form by the tags) of the screen definition information 32D.

When it is determined that the definition information of the second extended application is included, the application control unit 22 determines whether the initialization definition (definition at the time of a starting event receptionist) is included in the definition information on the second specified extended application (step S122). For example, the application control unit 22 determines existence of the initialization definition by whether the identification information “onInit” of the starting event is set as the attribute value (id value) of the action tag defined as the definition information on the second extended application.

When it is determined that the initialization definition is included, the application control unit 22 acquires the application information 2302 of the second extended application (step S123). The application control unit 22 accesses the application information storage unit 23, and acquires the corresponding application information 23D2 (default ownership application information of the extended application) based on the application identification information.

The application control unit 22 requests acquisition of a display component from the second extended application (step S124). At this time, the application control unit 22 sends the display component storage address information of the acquired application information 23D2 to the second extended application.

The second extended application requests display component acquisition of the screen generating unit 332 by the screen control unit 312 (step S131). At this time, the screen control unit 312 sends the display component storage address information received at the time of the display component acquisition request, to the screen generating unit 332.

The screen generating unit 332 accesses the display component storage unit 342, and acquires the corresponding display component (function selection components of the second extended application) based on the display component storage address information received at the time of the display component acquisition request (step S132). The screen generating unit 332 sends the acquired display component to the screen control unit 312 (step S133).

The screen control unit 312 answers the display component received as the acquired result to the application control unit 22 of the display component acquisition request source (step S134).

The application control unit 22 forms the acquired display component according to the screen definition information 32D1 of the first extended application, and arranges the acquired display component on the generated screen of the first extended application, and generates a starting screen (step S141).

The application control unit 22 sets the ownership to the first extended application (step S142), and requests screen displaying of the panel control unit 21 of the SDK/J 16 (step S143). At this time, the application control unit 22 sends the data of the generated starting screen to the panel control unit 21.

The panel control unit 21 displays the starting screen received at the time of the screen-display request, on the screen of the operation panel 120 (step S151).

Accordingly, in the image processing device 100 of this embodiment, at the time of starting of the image processing device, the extended application 17 which is the default ownership application is requested to generate a screen, and the function selection component is collected from another extended application 17 and the collected function selection component is arranged on the screen to be generated, so that a starting screen is generated. Thereby, in the image processing device 100 of this embodiment, the operational screen in which a plurality of functions of the extended application 17 can be selected at once can be displayed.

When it is determined at step S121 or step S122 that the applicable definition is not included, the application control unit 22 uses the generated screen of the first extended application as a starting screen, and the control is shifted to the step S142.

At the step S141, the application control unit 22 arranges the display component acquired from the second extended application corresponding to the screen change destination on the generated screen acquired from the first extended application so that the starting screen is generated. However, the present disclosure is not limited to this embodiment.

A method of requesting an extended application to generate a starting screen may be used for generation of a starting screen. For example, the above-described process may be arranged so that the application control unit 22 sends the application information of the second extended application to the first extended application, and requests the first extended application to generate the starting screen. In the first extended application, the application screen in which the display component of the second extended application is arranged is generated based on the received application information. The generated screen from the first extended application is received at the application control unit 22.

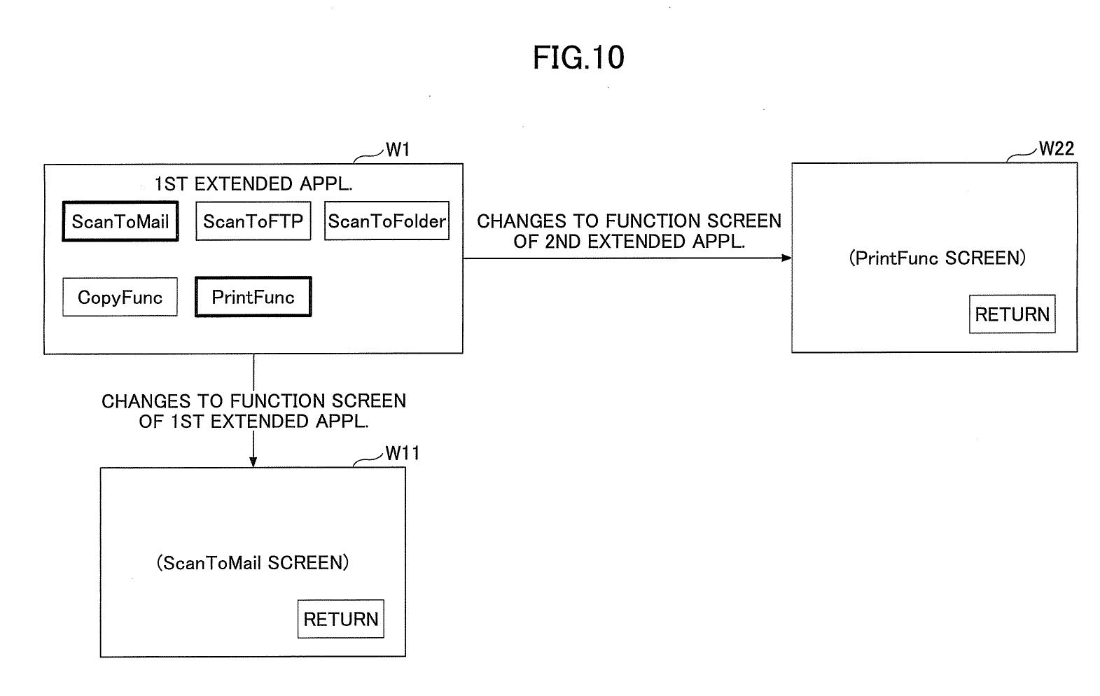

FIG. 10 is a diagram showing an example of a screen change in the image processing device of this embodiment. As shown in FIG. 10, when a ScanToMail function of the first extended application in the extended application screen W1 (which is the starting screen) is selected, a screen change operation is performed from the extended application screen W1 to the ScanToMail screen W11. When a PrintFunc function of the second extended application is selected, an operation of a screen change from the extended application screen W1 to the PrintFunc screen W22 is performed as shown in FIG. 10.

In the screen control function of this embodiment, in order to perform such screen change operation, the following process is performed.

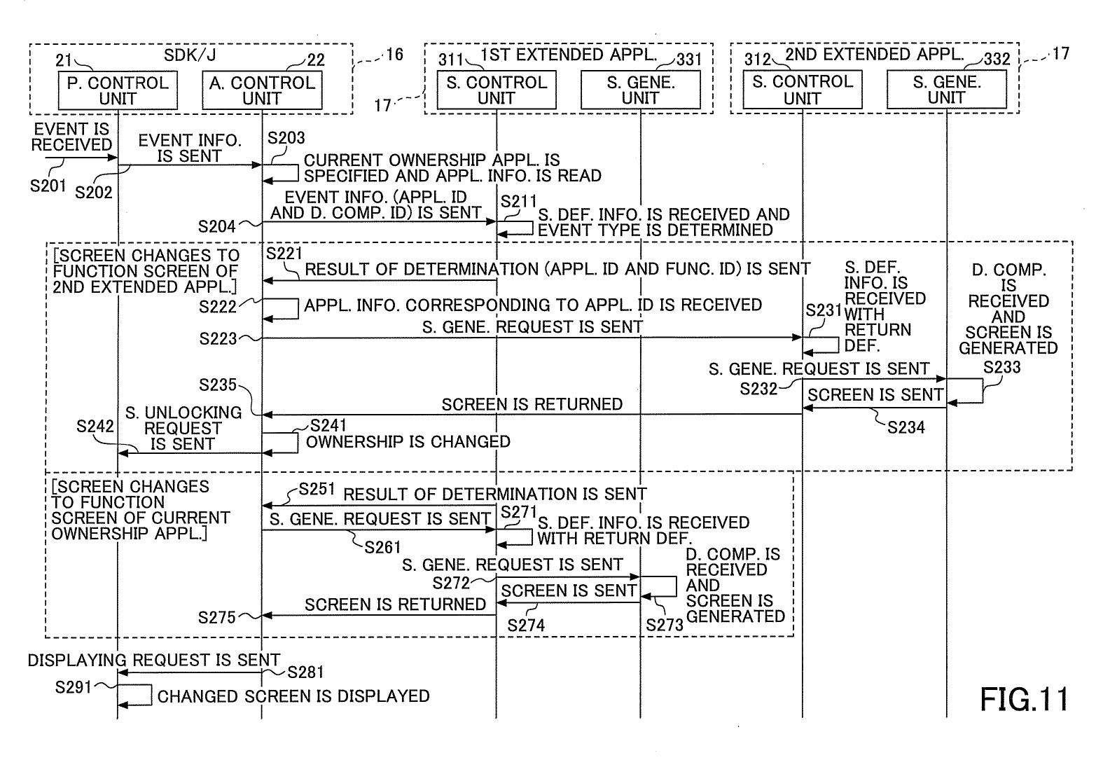

FIG. 11 is a sequence diagram for explaining a process of screen control in the image processing device of this embodiment. An example of the screen control process which performs the operation shown in FIG. 10 is shown in FIG. 11.

As shown in FIG. 11, when the panel control unit 21 receives an event by a screen manipulation (step S201), the event information is notified to the application control unit 22 (step S202). At this time, the panel control unit 21 associates the application identification information, selection component identification information, etc., a display screen and a display component with event information, and sends them to the application control unit 22.

When the event information is received, the application control unit 22 specifies the extended application 17 which has the current ownership, and acquires the application information 23D of the specified extended application 17 (step S203).

The application control unit 22 specifies the ownership application (the extended application which displays the current screen) based on the ownership setting. In the case of FIG. 10, the application control unit 22 specifies the first extended application as the ownership application and acquires the application information 23D1 of the first extended application from the application information storage unit 23 based on the application identification information. When the information is already acquired, the application information 23D1 temporarily stored on the memory may be specified.

The application control unit 22 sends the event information to the first extended application that is the specified ownership application (step S204). At this time, the application control unit 22 sends the application identification information of the received event information, the selection component identification information, etc. to the first extended application.

By the screen control unit 311, the first extended application acquires the screen definition information 32D1, and determines the event type (step S211). First, the screen control unit 311 accesses the screen definition information storage unit 321, and acquires the corresponding screen definition information 32D1 based on the application identification information received at the time of the event information. When the information is already acquired, the screen definition information 32D1 temporarily stored on the memory may be specified.

Subsequently, the screen control unit 311 specifies the corresponding definition information by accessing the screen definition information 32D1 based on the selection component identification information. The screen control unit 311 determines whether the identification information “onClick” of the selection button depression event is set as the attribute value (id value) of the action tag defined as the specified definition information. The screen control unit 311 determines the event type depending on whether the kind information “switchApl” of the screen change event is set up in the attribute value (eventType value) of the uiEvent tag in the action tag in which the identification information “onClick” is set up. When the screen control unit 311 has checked that the kind information of the screen change event is set up, the screen control unit 311 acquires the identification information of the application of the screen change destination (identification information of the screen change destination function) set to the other attribute value, as a result of determination of the screen change event.

The screen control unit 311 sends to the application control unit 22 of the event-type determination requesting unit the acquired application identification information (functional identification information) as a result of determination (step S221).

The application control unit 22 specifies the function of the extended application 17 corresponding to the screen change destination based on the application identification information (functional identification information) received as a result of determination of the screen change event.

For example, the application control unit 22 compares the received application identification information with the application identification information of the extended application 17 (ownership application) which displays the current screen, and if not in agreement, the application control unit 22 specifies the function of the extended application 17 in the received application identification information as the screen change destination.

The application control unit 22 specifies the function of the extended application 17 which displays the current screen as the screen change destination, when only the functional identification information is received as a result of determination of the screen change event. Therefore, the processing of the application control unit 22 performed after the event-type determination in this embodiment is divided into the case in which the function of the ownership application (first extended application) is specified as the screen change destination, and the case in which the function of the second extended application is specified as the screen change destination.

In the latter case, when the application identification information and the functional identification information are received as a result of determination of the screen change event (step S221), the application control unit 22 acquires the application information 23D applicable to the received application identification information (step S222). In the case of FIG. 10, the application control unit 22 receives the identification information of the second extended application, and the identification information of the PrintFunc function.

The application control unit 22 accesses application information storage unit 23, and acquires application information 23D2 (application information on the second extended application) which corresponds based on application identification information.

The application control unit 22 requests screen generation of the second extended application specified as the screen change destination (step S223). At this time, the application control unit 22 sends the display component storage address information of the acquired application information 23D2 and the functional identification information received as a result of the determination, to the second extended application. The application control unit 22 sends the parameter which requests addition of the return button (a selection component for returning to the preceding screen) to the second extended application. The application control unit 22 also sends the screen base data to the second extended application.

By the screen control unit 312, the second extended application accesses the screen definition information storage unit 322, and acquires the screen definition information 32D22 (definition information of a PrintFunc function) which corresponds based on the functional identification information received at the time of a screen generating request (step S231). When the information is already acquired, the screen definition information 32D22 temporarily stored on the memory may be specified. At this time, the screen control unit 312 checks the existence of the returning definition (existence of the definition information of the return button) by accessing the screen definition information 32D22 acquired or specified.

The screen control unit 312 sends a screen generating request to the screen generating unit 332 of the second extended application (step S232). At this time, the screen control unit 312 sends the screen definition information 32D22, the screen base data, and the display component storage address information received at the time of a screen generating request, to the screen generating unit 332. The screen control unit 312 requests addition of the button which returns to the screen generating unit 332, only when the returning definition is checked.

The screen generating unit 332 accesses the display component storage unit 342, and, based on the display component storage address information received at the time of a screen generating request, the screen generating unit 332 acquires the applicable display component, the screen generating unit 332 forms and arranges the acquired display component according to the screen definition information 32D22 received at the time of the screen generating request, so that a screen (PrintFunc screen) is generated based on the screen base data (step S233). At this time, the screen generating unit 332 adds the return button to the generated screen according to the display component addition request. The screen generating unit 332 sends the generated screen to the screen control unit 312 (step S234).

The screen control unit 312 answers the generated screen received as the generated result to the application control unit 22 of the screen generating request source (step S235).

The application control unit 22 changes the ownership into the extended application 17 (first extended application to second extended application) of the screen change destination (step S241), and requests unlocking of the display screen to the panel control unit 21 (step S242).

When the application control unit 22 receives only functional identification information as a result of determination of a screen change event (step S251), screen generation of the first extended application specified as the screen change destination is requested (step S261). In the case of FIG. 10, the application control unit 22 receives the identification information of a ScanToMail function. At this time, the application control unit 22 sends the display component storage address information of the acquired application information 23D1 and the functional identification information, received as a result of determination, to the first extended application. The application control unit 22 sends the parameter which requests addition of the return button to the first extended application. The application control unit 22 also sends the screen base data to the first extended application.

By the screen control unit 311, the first extended application accesses the screen definition information storage unit 321, and acquires the corresponding screen definition information 32D11 (definition information of the ScanToMail function) based on the functional identification information received at the time of the screen generating request (step S271). When the information is already acquired, the screen definition information 32D11 temporarily stored on the memory may be specified. At this time, the screen control unit 311 checks the existence of the returning definition by accessing the screen definition information 32D11 acquired or specified.

The screen control unit 311 sends a screen generating request to the screen generating unit 331 (step S272). At this time, the screen control unit 311 sends the screen definition information 32D11, the screen base data, the display component storage address information received at the time of a screen generating request, etc. to the screen generating unit 331.

The screen control unit 311 requests addition of the button for returning to the screen generating unit 331, only when the returning definition is checked.

The screen generating unit 331 acquires an applicable display component (functional screen composition display component) from the display component storage unit 341, forms and arranges the acquired display component according to the screen definition information 32D11, so that a screen (ScanToMail screen) is generated based on the screen base data (step S273). At this time, the screen generating unit 332 adds the return button to the generated screen according to the display component addition request.

The screen generating unit 331 sends the generated screen to the screen control unit 311 (step S274). The screen control unit 311 answers the generated screen received as the generated result to the application control unit 22 of the screen generating request source (step S275).

When the ownership application is specified as the screen change destination, the application control unit 22 does not perform changing of the ownership, unlocking of the display screen, etc.

Subsequently, the application control unit 22 sends a screen displaying request to the panel control unit 21 (step S281). At this time, the application control unit 22 sends the data of the functional screen (change destination screen) generated by the two types of the process by the extended application 17 of the screen change destination to the panel control unit 21.

The panel control unit 21 displays the change destination screen received at the time of a screen-display request on the screen of operation panel 120 (step S291). At this time, the panel control unit 21 sets the non-displaying of the screen (ownership application screen) of the screen change source, and locks the display screen.

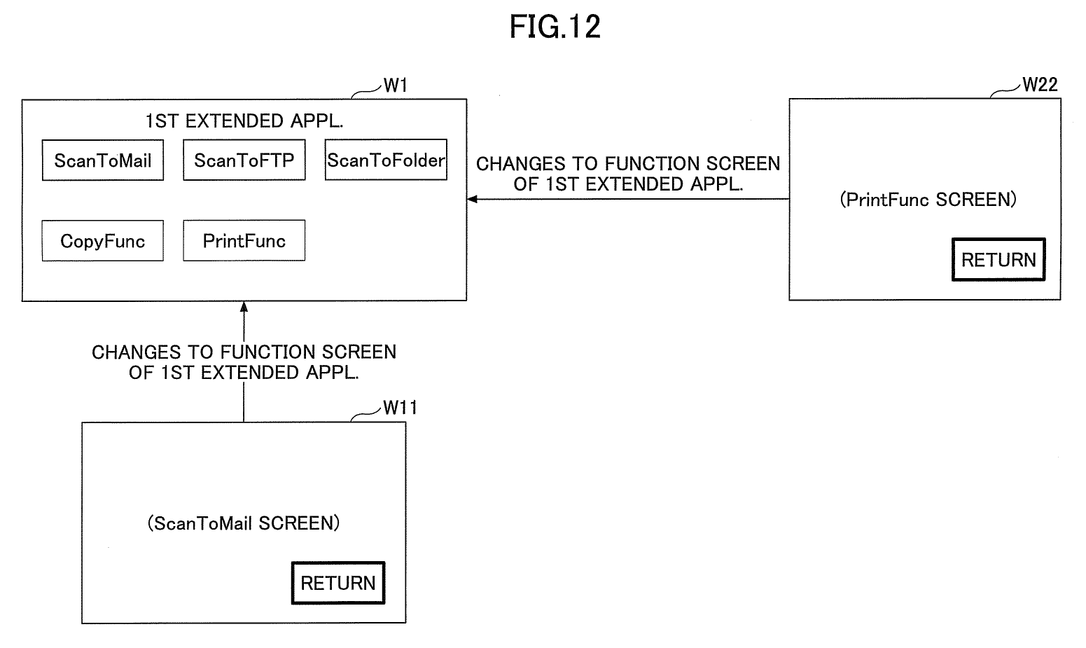

FIG. 12 is a diagram showing the example of the screen change of this embodiment.

When the return button of the ScanToMail screen W11 of the first extended application is depressed, the operation of a screen change to the extended application screen W1 from the ScanToMail screen W11 is performed as shown in FIG. 12. When the return button of the PrintFunc screen W22 of the second extended application is depressed, the operation of a screen change to the extended application screen W1 is performed as shown in FIG. 12.

In the screen control function of this embodiment, in order to perform such screen change operation, the following process is performed.

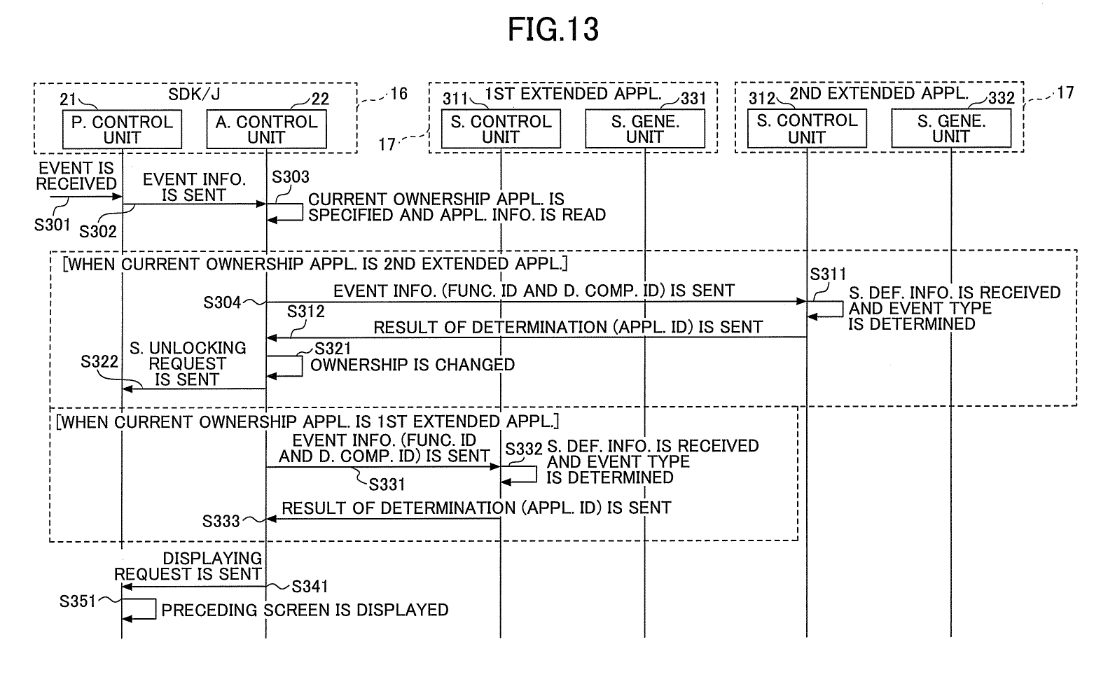

FIG. 13 is a sequence diagram for explaining a process of screen control of this embodiment. An example of the screen control process which performs the operation shown in FIG. 12 is shown in FIG. 13.

As shown in FIG. 13, when the panel control unit 21 receives an event by a screen manipulation (step S301), the event information is notified to the application control unit 22 (step S302). At this time, the panel control unit 21 associates the functional identification information, the selection component identification information, the display screen and the display component with the event information, and sends them to the application control unit 22.

When the event information is received, the application control unit 22 specifies the extended application 17 which has the current ownership, and acquires the application information 230 of the specified extended application 17 (step S303). The application control unit 22 specifies the ownership application (the extended application which displays the current screen) based on the ownership setting. When the information is already acquired, the application information 23D temporarily stored on the memory may be specified.

In this embodiment, the processing of the application control unit 22 performed after the ownership application is specified is divided into the case in which the ownership application is specified as the first extended application, and the case in which the ownership application is specified as the second extended application.

In the latter case, the application control unit 22 sends the event information to the second extended application that is the specified ownership application (step S304). At this time, the application control unit 22 sends the functional identification information of the received event information, the selection component identification information, etc. to the second extended application.

By the screen control unit 312, the second extended application acquires the screen definition information 32D22 (definition information of a PrintFunc function) applicable to the functional identification information, and determines the event type (step S311).

As mentioned above, an event-type determination is performed based on the attribute value (eventType value) of the uiEvent tag in the action tag with which the identification information of the return button depression event is set up by accessing the screen definition information 32D22. When the screen control unit 312 has checked that the kind information of the screen change event is set up, the screen control unit 312 acquires the identification information of the application corresponding to the screen change destination set as other attribute values (return point identification information of the application) as a result of determination of the screen change event.

In the case of FIG. 12, the application control unit 22 acquires the identification information of the first extended application.

The screen control unit 312 answers, to the application control unit 22 of the event-type determination requesting unit, the acquired application identification information as a result of the determination (step S312).

The application control unit 22 changes the ownership into extended application 17 (second extended application to first extended application) of the screen change destination (return point) (step S321), and requests unlocking of the screen display to the panel control unit 21 (step S322).

When the application control unit 22 receives only application identification information as a result of determination of a screen change event at this time, based on the received application identification information, it is determined whether it is necessary to change the ownership or not. For example, it is determined that the application control unit 22 comparing the received application identification information with the application identification information of extended application 17 (ownership application) which displays the current screen, and changing ownership into the extended application 17 shown in the received application identification information, if it is not in agreement.

The application control unit 22 sends the event information to the first extended application that is the specified ownership application (step S331). At this time, the application control unit 22 sends the functional identification information of the received event information, the selection component identification information, etc. to the first extended application.

By the screen control unit 311, the first extended application acquires screen definition information 32D11 (definition information of a ScanToMail function) applicable to the functional identification information, and determines the event type (step S332).

The determination of an event type is the same as that in the above-described process, and a description thereof will be omitted.

The screen change destination set as other corresponding attribute values when the screen control unit 311 has checked that the kind information of the screen change event is set up the identification information of the application (return point identification information of the application) is acquired as a result of determination of the screen change event.

In the case of FIG. 12, the application control unit 22 acquires the identification information of the first extended application. The screen control unit 311 answers to the application control unit 22 of event-type determination requesting unit considering the acquired application identification information as a result of determination (step S333).

It is determined with not changing ownership, since the application identification information which performed the change determination of the ownership and is received, the application identification information of extended application 17 (ownership application) which displays the current screen, and the corresponding application control unit 22. Therefore, the application control unit 22 does not perform changing of the ownership, unlocking of the display screen, etc.

Subsequently, the application control unit 22 sends a request of displaying the preceding-screen to the panel control unit 21 (step S341).

The panel control unit 21 displays the extended application screen W1 of the default ownership application on the screen of the operation panel 120 (step S351). At this time, the panel control unit 21 sets the non-displaying of the screen (functional screen) of the screen change source, and locks the display screen.

The image processing device 100 of this embodiment causes the extended application 17 to generate each functional screen, and performs integrated control of the changes of functional screens by the application control unit 22. Thereby, in the image processing device 100 of this embodiment, a screen change can be performed between the functions of the different extended applications 17 through each extended application screen.

Next, it is supposed that the screen control function is arranged so that the extended application screens of all the installed extended applications are generated at the time of starting.

When the screen control function is used, it is not necessary to perform the screen generation and the processing time of screen displaying or a display screen change can be shortened in the screen change between the extended applications after starting.

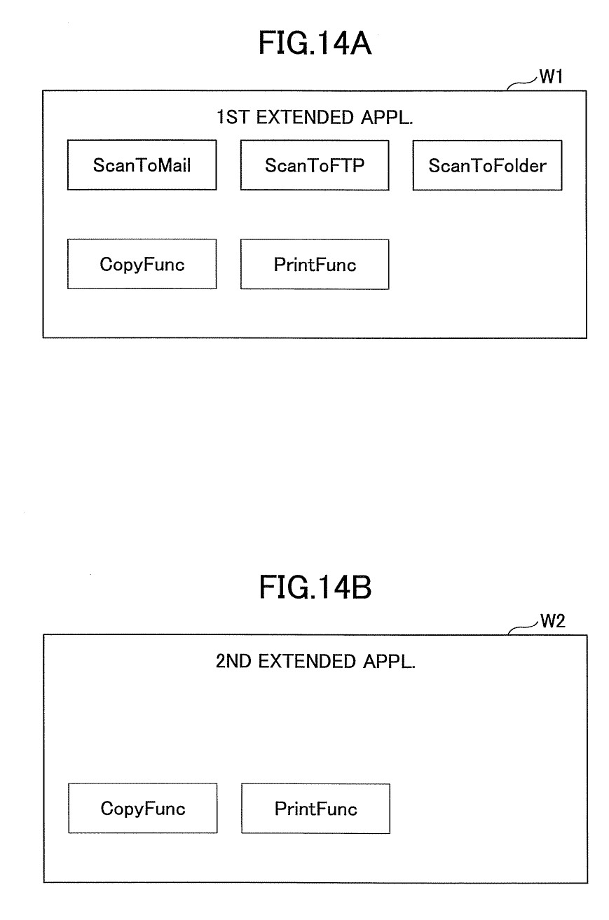

FIG. 14A and FIG. 14B are diagrams showing examples of a starting screen in the image processing device of this embodiment. FIG. 14A shows an example of an extended application screen W1 of the first extended application which is set up as the default ownership application at the time of starting of the image processing device 100. FIG. 14B shows an example of an extended application screen W2 of the second extended application which is another extended application 17 different from the default ownership application.

In the screen control function of this embodiment, in order to carry out such screen change operation, the following process is performed.

In the following, the difference between the process of this embodiment and the previously described process with reference to FIGS. 9 to 13 will be described.

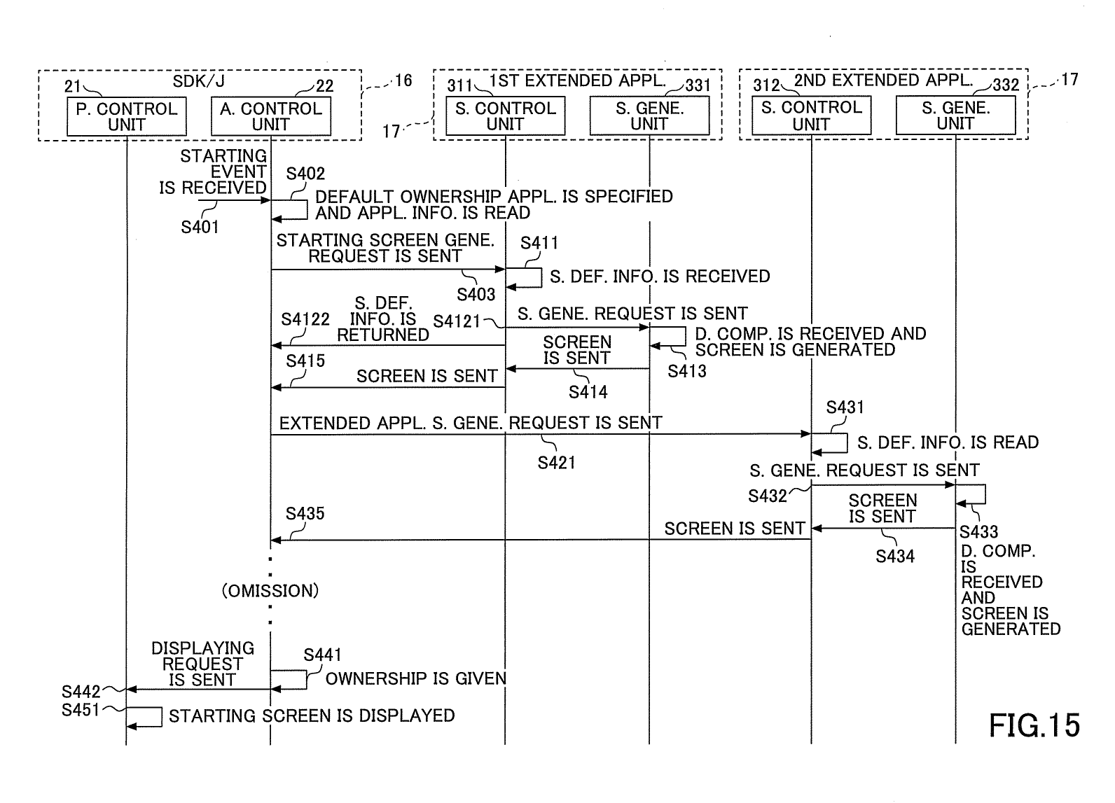

FIG. 15 is a sequence diagram for explaining a process of screen control at the time of starting of this embodiment.

In the image processing device 100, the extended application screens W1 and W2 shown in FIGS. 14A and 14B are generated by the process shown in FIG. 15, and the extended application screen W1 is displayed as a starting screen.

As shown in FIG. 15, when the image processing device 100 is started and the SDK/J 16 receives a starting event (step S401), the application control unit 22 specifies the installed extended application 17 and the default ownership application, and acquires the application information 23D of the specified extended application 17 (step S402).

The application control unit 22 specifies the first extended application that is the default ownership application based on the identification information (application identification information) of the default starting application set up beforehand.

The application control unit 22 accesses the application information storage unit 23, and acquires the application information 23D of all the installed extended applications.

The application control unit 22 requests generation of a starting screen of the first extended application that is the specified default ownership application (step S403). At this time, the application control unit 22 sends the application identification information, the display component storage address information of the acquired application information 23D1, etc. to the first extended application. The application control unit 22 also sends the screen base data to the first extended application.

By the screen control unit 311, the first extended application accesses the screen definition information storage unit 321, and acquires the corresponding screen definition information 32D1 based on the application identification information received at the time of the starting screen generating request (step S411).

The screen control unit 311 sends a screen generating request to the screen generating unit 331 of the first extended application (step S4121). At this time, the screen control unit 311 sends the acquired screen definition information 32D1, the screen base data, the display component storage address information received at the time of the starting screen generating request, etc. to the screen generating unit 331.

The screen control unit 311 sends to the application control unit 22 of the requesting unit the screen definition information 32D1 at the time of the starting screen generating request (step S4122).

The screen generating unit 331 acquires the applicable display component (function selection components of the first extended application) from the display component storage unit 341, arranges the acquired display component on the screen according to the screen definition information 32D1, and generates the extended application screen W1 based on the screen base data (step S413).

The screen generating unit 331 sends the generated screen to the screen control unit 311 (step S414).

The screen control unit 311 answers the generated screen received as the generated result to the application control unit 22 of the starting screen generating request source (step S415).

Subsequently, the application control unit 22 sends a request of generation of an extended application screen to the installed second extended application (other than the default ownership application extended application) (step S421). At this time, the application control unit 22 sends the application identification information, the display component storage address information of the acquired application information 23D2, etc. to the second extended application. The application control unit 22 also sends the screen base data to the second extended application.

By the screen control unit 312, the second extended application accesses the screen definition information storage unit 322, and acquires the corresponding screen definition information 32D2 based on the application identification information received at the time of the extended application screen generating request (step S431).

The screen control unit 312 sends a screen generating request to the screen generating unit 332 of the second extended application (step S432). At this time, the screen control unit 312 sends the acquired screen definition information 32D2, the screen base data, the display component storage address information received at the time of the extended application screen generating request, etc. to the screen generating unit 332. The screen control unit 312 does not send the acquired screen definition information 32D2 to the application control unit 22 because the received screen generating request is not a starting screen but an extended application screen.

The screen generating unit 332 acquires an applicable display component (function selection components of the second extended application) from the display component storage unit 342, arranges the acquired display component on the screen according to the screen definition information 32D2, and generates the extended application screen W2 based on the screen base data (step S433).

The screen generating unit 332 sends the generated screen to the screen control unit 312 (step S434).

The screen control unit 312 answers the generated screen received as the generated result to the application control unit 22 of the extended application screen generating request source (step S435).

The processing of the steps S421 to S435 is performed in order for the number of the installed extended applications 17.

The subsequent processing after the extended application screens of all the installed extended applications are generated is the same as that of the processing of the steps S121 to S151 of FIG. 9, and a description thereof will be omitted.

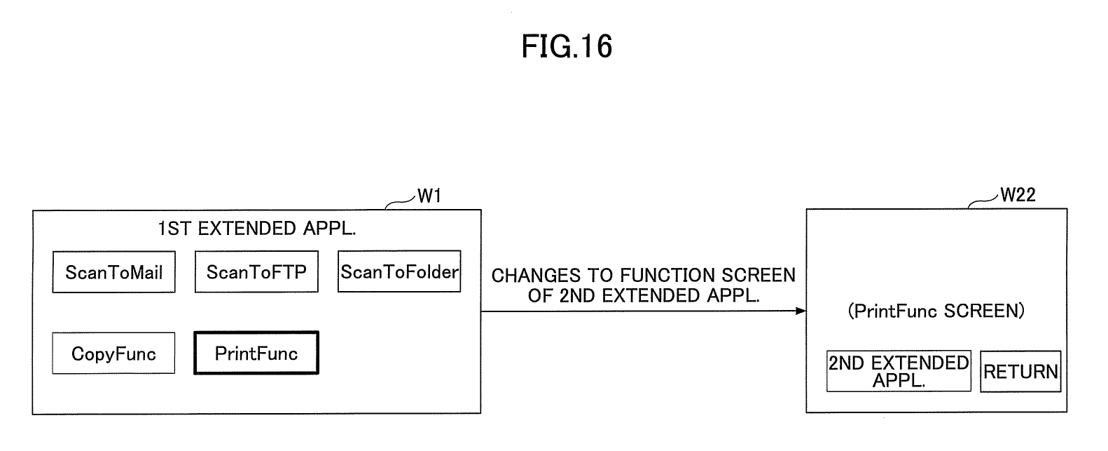

Next, FIG. 16 is a diagram showing the example of the screen change of this embodiment.

When the PrintFunc function of the second extended application is selected from the extended application screen W1 which is a starting screen, an example of operation of a screen change to the PrintFunc screen W22 is shown in FIG. 16.

At this time, the extended application selection button which requests the screen change to the second extended application to which this function belongs is added to the PrintFunc screen W22 which is the screen change destination. The user can return to the extended application screen W1 by the depression of the return button, and can also select another function (CopyFunc function) of the second extended application.

However, many function selection buttons will be displayed in the case where there are many functions which are provided by the installed extended applications 17. Therefore, it is difficult for the user to select the function to be executed. It is desirable that other functions can be selected from the extended application screen of the extended application 17 (the same extended application to which the function belongs) where the function is related. Therefore, in this embodiment, the functional screen W22 including the extended application selection button as shown in FIG. 16 is provided. In the screen control function of this embodiment, in order to perform such screen change operation, the following process is performed.

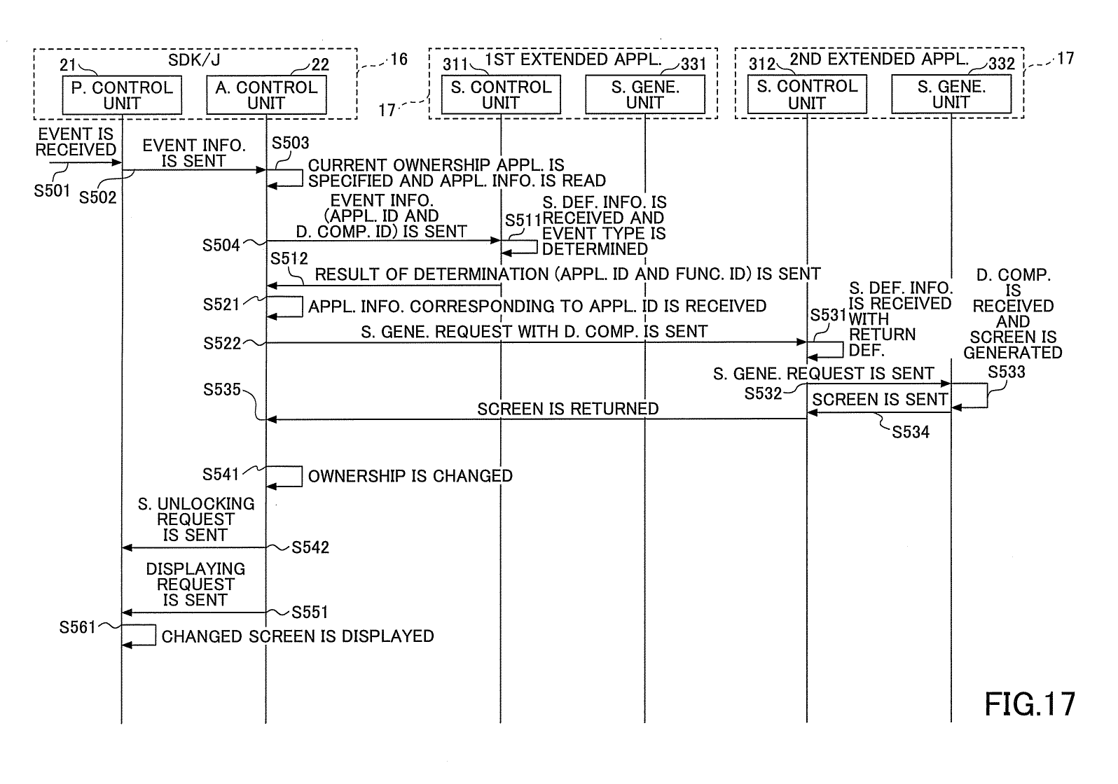

FIG. 17 is a sequence diagram for explaining a process of screen control of this embodiment. An example of the screen control process which performs the operation shown in FIG. 16 is shown in FIG. 17. As shown in FIG. 17, when the panel control unit 21 receives an event by a screen manipulation (step S501), the event information is notified to the application control unit 22 (step S502). At this time, the panel control unit 21 associates the application identification information, the selection component identification information, the display screen and the display component with the event information, and sends them to the application control unit 22.

The application control unit 22 specifies the extended application 17 which has the current ownership, after the event information is received (step S503). The application control unit 22 specifies the ownership application (the extended application which displays the current screen) based on the ownership setting.

In the case of FIG. 16, the first extended application, the application control unit 22 specifies with the ownership application and the application information 23D1 of the first extended application is specified based on the application information 23D acquired at the time of starting.

The application control unit 22 sends the event information to the first extended application that is the specified ownership application (step S504). At this time, the application control unit 22 sends the application identification information of the received event information and the selection component identification information, etc. to the first extended application.

By the screen control unit 311, the first extended application acquires screen definition information 32D1, and determines event type (step S511).

As mentioned above, an event-type determination is performed based on the attribute value (eventType value) of the uiEvent tag in the action tag in which the identification information of the PrintFunc function selection button depression event is set up by accessing the screen definition information 32D1. The screen change destination set as other corresponding attribute values when the screen control unit 311 has checked that the kind information of a screen change event is set up, the identification information of an application and the identification information of a screen change destination function are acquired as a result of determination of a screen change event.

In the case of FIG. 16, the screen control unit 311 acquires the identification information of the second extended application and the identification information of the PrintFunc function.

The screen control unit 311 answers, to the application control unit 22 of the event-type determination requesting unit, the application identification information and the functional identification information acquired as a result of determination (step S512).

The application control unit 22 specifies the PrintFunc function of the second extended application corresponding to the screen change destination based on the application identification information and the functional identification information received as a result of determination of a screen change event.

Because the received application identification information and the application identification information of the application control unit 22 of the extended application 17 (ownership application) which displays the current screen do not correspond in the case of FIG. 16, the function (PrintFunc function) of the second extended application shown in the received application identification information is specified as the screen change destination.

When the application identification information and the functional identification information are received as a result of determination of the screen change event, the application control unit 22 specifies the application information 23D2 (application information on the second extended application) which corresponds to the received application identification information out of application information 23D acquired at the time of starting (step S521).

The application control unit 22 sends a screen generating request to the second extended application specified as the screen change destination (step S522). At this time, the application control unit 22 sends the functional identification information received as a result of determination, the display component storage address information on application information 23D2, etc. to the second extended application.

The application control unit 22 sends the parameter which requests addition of the return button and an extended application selection button (a function belongs the selection component which can direct to change to the second extended application) to the second extended application. The application control unit 22 also sends the screen base data to the second extended application.

By the screen control unit 312, the second extended application accesses the screen definition information storage unit 322, and acquires the corresponding screen definition information 32D22 (definition information of a PrintFunc function) based on the functional identification information received at the time of the screen generating request (step S531). When the information is already acquired, the screen definition information 32D22 temporarily stored on the memory may be specified.

At this time, the screen control unit 312 checks the existence (existence of the definition information on the return button) of the returning definition by accessing the screen definition information 32D22 acquired or specified.

The screen control unit 312 sends a screen generating request to the screen generating unit 332 of the second extended application (step S532). At this time, the screen control unit 312 sends the screen definition information 32022, the screen base data, the display component storage address information received at the time of the screen generating request, etc. to the screen generating unit 332.

The screen control unit 312 requests addition of an extended application selection button. The screen control unit 312 requests addition of the button for returning to the screen generating unit 332, only when the returning definition is checked.

The screen generating unit 332 acquires the applicable display component (functional screen composition display component) from the display component storage unit 342, arranges the acquired display component on the screen according to the screen definition information 32D22, and generates a screen (PrintFunc screen) based on the screen base data (step S533). At this time, the screen generating unit 332 adds the return button and extended application selection button to the generated screen according to the display component addition request.

The screen generating unit 332 sends the generated screen to the screen control unit 312 (step S534). The screen control unit 312 answers the generated screen received as the generated result to the application control unit 22 of the screen generating request source (step S535).

The application control unit 22 changes the ownership into the second extended application (first extended application to second extended application) of the screen change destination (step S541), and requests unlocking of the display screen to the panel control unit 21 (step S542).

The application control unit 22 requests screen displaying to the panel control unit 21 (step S551). At this time, the application control unit 22 sends the data of the PrintFunc screen W22 (change destination screen) generated by the above-described processing by the second extended application of the screen change destination to the panel control unit 21.

The panel control unit 21 displays the change destination screen received at the time of screen-display request on the screen of operation panel 120 (step S561). At this time, the panel control unit 21 sets the non-displaying of the screen (ownership application screen) of the screen change source, and locks the display screen.

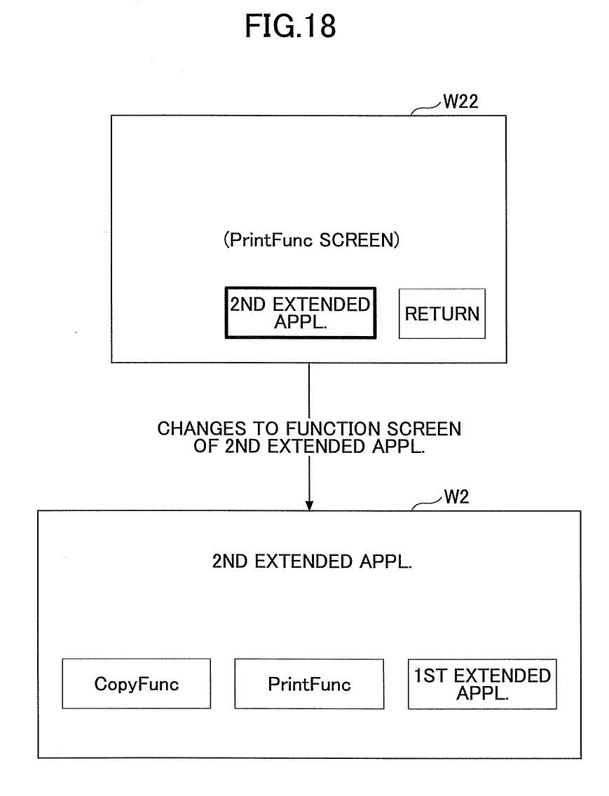

FIG. 18 is a diagram showing the example of the screen change of this embodiment.

When the extended application selection button on the PrintFunc screen is depressed, an example of operation of a screen change from the PrintFunc screen W22 to the extended application screen W2 is performed as shown in FIG. 18. At this time, the extended application selection button which requests the screen change to the first extended application is added to the extended application screen W2 which is the screen change destination.

In the screen control function of this embodiment, in order to perform such screen change operation, the following process is performed.

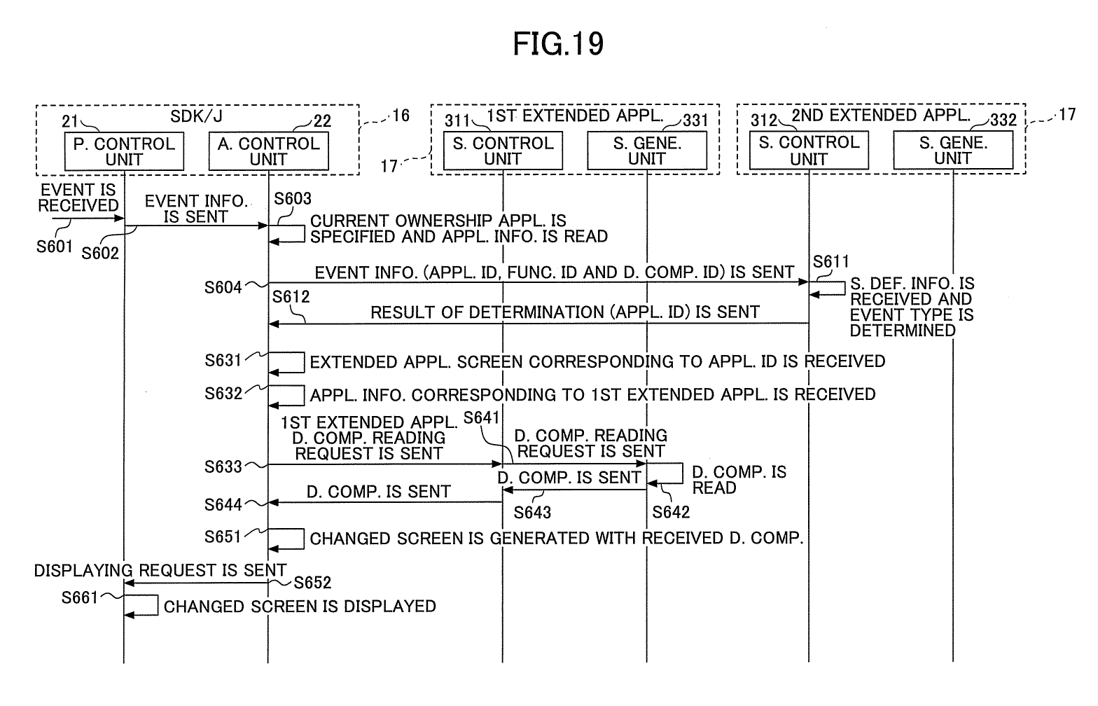

FIG. 19 is a sequence diagram for explaining a process of screen control of this embodiment.

An example of the screen control process which performs the operation shown in FIG. 18 is shown in FIG. 19. As shown in FIG. 19, when the panel control unit 21 receives an event by a screen manipulation (step S601), the event information is notified to the application control unit 22 (step S602). At this time, the panel control unit 21 associates the application identification information, the functional identification information, the selection component identification information, the display screen and the display component with the event information, and sends them to the application control unit 22.

The application control unit 22 specifies the extended application 17 which has the current ownership, if the event information is received (step S603). The application control unit 22 specifies the owner application (extended application which displays the current screen) based on the ownership setting.

In the case of FIG. 18, the application control unit 22 specifies the second extended application as the ownership application, and specifies the application information 23D2 of the second extended application from the application information 23D acquired at the time of starting.

The application control unit 22 sends the event information to the second extended application that is the specified ownership application (step S604). At this time, the application control unit 22 sends the application identification information, the functional identification information, the selection component identification information, etc. of the received event information to the second extended application.

By the screen control unit 312, the second extended application acquires the screen definition information 32D22, and determines the event type (step S611).

In the case of the operation shown in FIG. 18, the screen control unit 312 acquires the identification information of the second extended application.

The screen control unit 312 answers to the application control unit 22 of the event-type determination requesting unit the acquired functional identification information as a result of the determination (step S612).

The application control unit 22 specifies the second extended application corresponding to the screen change destination based on the application identification information received as a result of determination of the screen change event.

Because the received application identification information and the application identification information of the application control unit 22 of extended application 17 (ownership application) which displays the current screen are not in agreement in the case of the operation shown in FIG. 18, the application control unit 22 specifies the second extended application in the received application identification information as the screen change destination.

The application control unit 22 specifies the extended application screen W2 which corresponds to the received application identification information from the extended application screen generated at the time of starting (step S631).

The application control unit 22 specifies the application information 23D1 (application information of the first extended application) which corresponds to the different extended application 17 (first extended application) from the screen change destination from the application information 23D acquired at the time of starting (step S632).

The application control unit 22 requests acquisition of an extended application selection component to the first extended application different from the screen change destination (step S633). At this time, the application control unit 22 sends the display component storage address information of the specified application information 23D1 etc. to the first extended application.

The first extended application requests display component acquisition to the screen generating unit 331 by the screen control unit 311 (step S641). At this time, the screen control unit 311 sends the display component storage address information received at the time of the extended application selection component acquisition request, to the screen generating unit 331.

The screen generating unit 331 accesses the display component storage unit 341, and acquires the corresponding display component (function selection components of the first extended application) based on the display component storage address information received at the time of the extended application selection component acquisition request (step S642).

The screen generating unit 331 sends the acquired extended application selection component to the screen control unit 311 (step S643). The screen control unit 311 answers the extended application selection component received as the acquired result to the application control unit 22 of the extended application selection component acquisition request source (step S644).

The application control unit 22 arranges the acquired extended application selection component on extended application screen W2 of the second specified extended application according to the screen definition information 32D2 of the second extended application, and generates the screen of the screen change destination (step S651).

The application control unit 22 requests screen displaying to the panel control unit 21 (step S652). At this time, the application control unit 22 sends the data of extended application screen W2 (change destination screen) of the second extended application specified as the screen change destination by the above-mentioned processing to the panel control unit 21.

The panel control unit 21 displays the change destination screen received at the time of screen-display request on the screen of operation panel 120 (step S661). At this time, the panel control unit 21 sets the non-displaying of the PrintFunc screen W22 (functional screen) of the screen change source.

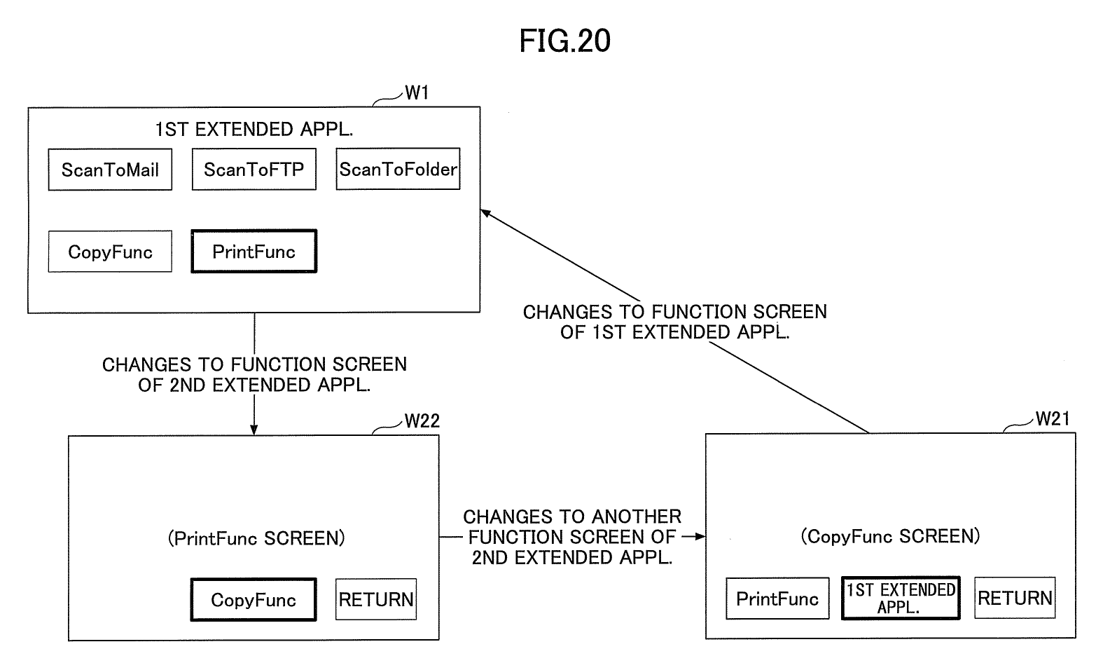

FIG. 20 is a diagram showing the example of the screen change of this embodiment. As shown in FIG. 20, when a PrintFunc function of the second extended application is selected from the extended application screen W1 which is the starting screen, an operation of a screen change to the PrintFunc screen W22 is performed. At this time, in a PrintFunc screen W22 which corresponds to a screen change destination, a function selection button for requesting the screen change to the CopyFunc function (or other functions) of the second extended application is added. In the case of FIG. 20, when the CopyFunc function is selected from the PrintFunc screen W22, the operation of the screen change to the CopyFunc screen W21 is performed. At this time, in the CopyFunc screen W21 which corresponds to the screen change destination, a function selection button for requesting the screen change to the first extended application that is the default ownership application is added. In the case of FIG. 20, when the first extended application is selected from the CopyFunc screen W21, the operation of the screen change to the extended application screen W1 is performed.

In the PrintFunc screen W22, the user can return to the extended application screen W1 by depressing the return button. If there is no selection button for the first extended application in the CopyFunc screen W21, the user has to depress the return button in the CopyFunc screen W21 and the return button in the PrintFunc screen W22 (twice) in order to return to the extended application screen W1. Therefore, the user may have a difficulty in selecting the default ownership application (the first extended application). To eliminate the problem, it is desirable that, at the time of performing the operation of a screen change between the functions of the extended application 17, the default ownership application can be selected from the functional screen W21. Therefore, in this embodiment, the functional screen W21 including the extended application selection button as shown in FIG. 20 is provided.

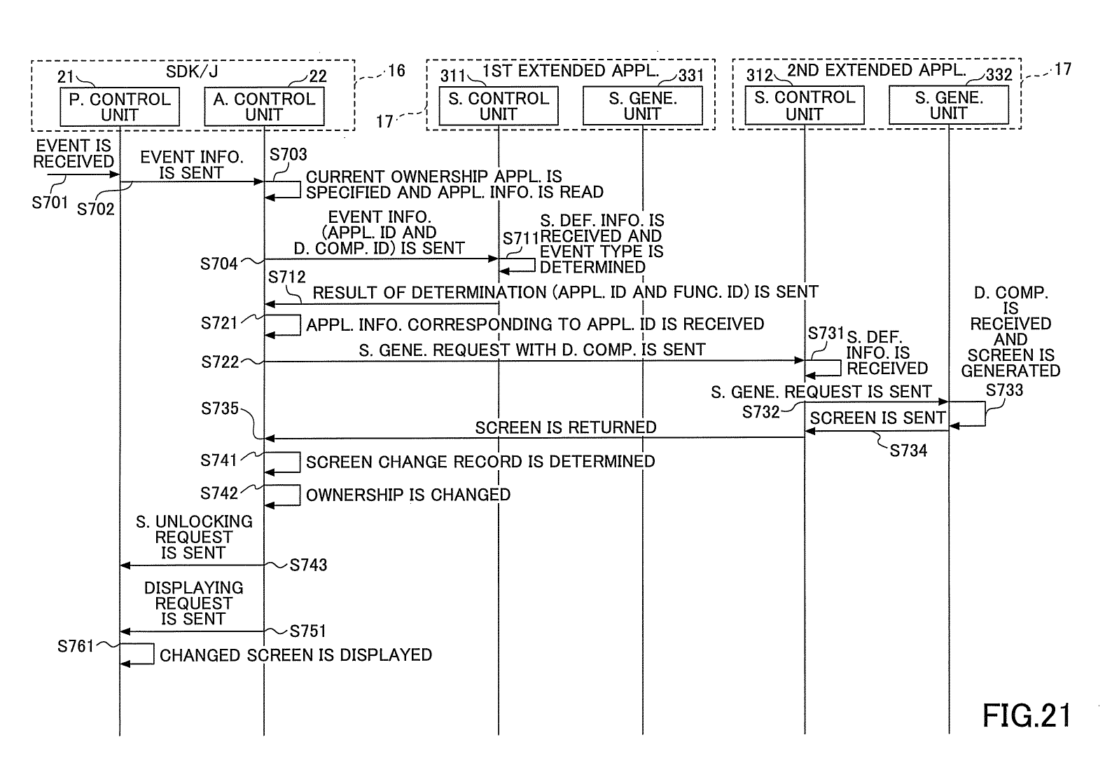

FIG. 21 is a sequence diagram for explaining a process of screen control of this embodiment. An example of the screen control process which performs the operation shown in FIG. 20 is shown in FIG. 21.

As shown in FIG. 21, when the panel control unit 21 receives an event by a screen manipulation (step S701), the event information is notified to the application control unit 22 (step S702). At this time, the panel control unit 21 associates the application identification information, the selection component identification information, the display screen and the display component with the event information, and sends them to the application control unit 22.

The application control unit 22 specifies the extended application 17 which has the current ownership, when the event information is received (step S703). The application control unit 22 specifies the ownership application (the extended application which displays the current screen) based on the ownership setting. In the case of FIG. 20, the application control unit 22 specifies the first extended application as the ownership application and specifies the application information 23D1 of the first extended application in the application information 23D acquired at the time of starting.

The application control unit 22 sends the event information to the first extended application that is the specified ownership application (step S704). At this time, the application control unit 22 sends the application identification information of the received event information, the selection component identification information, etc. to the first extended application.

By the screen control unit 311, the first extended application acquires the screen definition information 32D1, and determines the event type (step S711).

As mentioned above, the event-type determination is performed based on the attribute value (eventType value) of the uiEvent tag in the action tag with which the identification information of the PrintFunc function selection button depression event is set up by accessing the screen definition information 3201. When the screen control unit 311 has checked that the kind information of the screen change event is set up, the screen control unit 311 acquires the identification information of the application corresponding to the screen change destination set as other corresponding attribute values and acquires the identification information of the screen change destination function as a result of the determination of the screen change event.

In the case of FIG. 20, the screen control unit 311 acquires the identification information of the second extended application and acquires the identification information of the PrintFunc function.

The screen control unit 311 answers to the application control unit 22 of the event-type determination requesting unit the application identification information and functional identification information acquired as a result of the determination (step S712).

The application control unit 22 specifies the PrintFunc function of the second extended application corresponding to the screen change destination based on the application identification information and the functional identification information received as a result of the determination of the screen change event.

In the case of FIG. 20, the received application identification information is not in agreement with the application identification information of the extended application 17 (ownership application) which displays the current screen, and the application control unit 22 specifies the function (PrintFunc function) of the second extended application in the received application identification information as the screen change destination.

When the application identification information and functional identification information are received as a result of determination of the screen change event, the application control unit 22 specifies the application information 23D2 (application information of the second extended application) which corresponds to the received application identification information, based on the application information 23D acquired at the time of starting (step S721).

The application control unit 22 sends a screen generating request to the second extended application specified as the screen change destination (step S722). At this time, the application control unit 22 sends the functional identification information received as a result of the determination, the display component storage address information of the application information 23D2, etc. to the second extended application. The application control unit 22 sends the parameter which requests addition of the return button and the function selection button (a selection component for requesting a screen change to another function (the CopyFunc function) of the second extended application) to the second extended application. The application control unit 22 sends the screen base data to the second extended application.

By the screen control unit 312, the second extended application accesses the screen definition information storage unit 322, and acquires the corresponding screen definition information 32D22 (definition information of the PrintFunc function) based on the functional identification information received at the time of the screen generating request (step S731). When the information is already acquired, the screen definition information 32D22 temporarily stored on the memory may be specified. At this time, the screen control unit 312 checks existence of the returning definition (existence of the definition information of the return button) by accessing the screen definition information 32D22 acquired or specified.

The screen control unit 312 sends a screen generating request to the screen generating unit 332 of the second extended application (step S732). At this time, the screen control unit 312 sends the screen definition information 32D22, the screen base data, the display component storage address information received at the time of the screen generating request, etc. to the screen generating unit 332. The screen control unit 312 requests addition of a function selection button to the screen generating unit 332. The screen control unit 312 requests addition of the button for returning to the screen generating unit 332, only when the existence of the returning definition is checked.

The screen generating unit 332 acquires an applicable display component (a functional screen composition display component and a CopyFunc function selection component) from the display component storage unit 342. The screen generating unit 332 arranges the acquired display component on the screen according to the screen definition information 32D22, so that a screen (PrintFunc screen) is generated based on the screen base data (step S733). At this time, the screen generating unit 332 adds the return button and the function selection button to the generated screen according to the display component addition request. The screen generating unit 332 sends the generated screen to the screen control unit 312 (step S734).

The screen control unit 312 answers the generated screen received as a result of the screen generation to the application control unit 22 of the screen generating request source (step S735).

The application control unit 22 determines the log of the screen change (step S741). The application control unit 22 records the preceding screen change operation and stores the same as the log information on the memory. The application control unit 22 determines whether the preceding screen of the screen change source is a functional screen, based on the screen change log information. When it is determined that the preceding screen is a functional screen, the application control unit 22 determines that it is necessary to add the extended application selection button of the default ownership application (first extended application) to the change destination screen. In the case of FIG. 20, the preceding screen is the extended application screen W1, and the application control unit 22 determines that it is not necessary to add the extended application selection button of the default ownership application (the first extended application).

The application control unit 22 changes the ownership into the second extended application (first extended application to second extended application) of the screen change destination (step S742), and requests unlocking of the display screen to the panel control unit 21 (step S743).

The application control unit 22 sends a screen displaying request to the panel control unit (step S751). At this time, the application control unit 22 sends the data of the PrintFunc screen W22 (the change destination screen), generated by the second extended application of the screen change destination in the above-described processing, to the panel control unit 21.

The panel control unit 21 displays the change destination screen, received at the time of the screen displaying request, on the screen of the operation panel 120 (step S761). At this time, the panel control unit 21 sets the non-displaying of the screen (ownership application screen) of the screen change source, and locks the display screen.

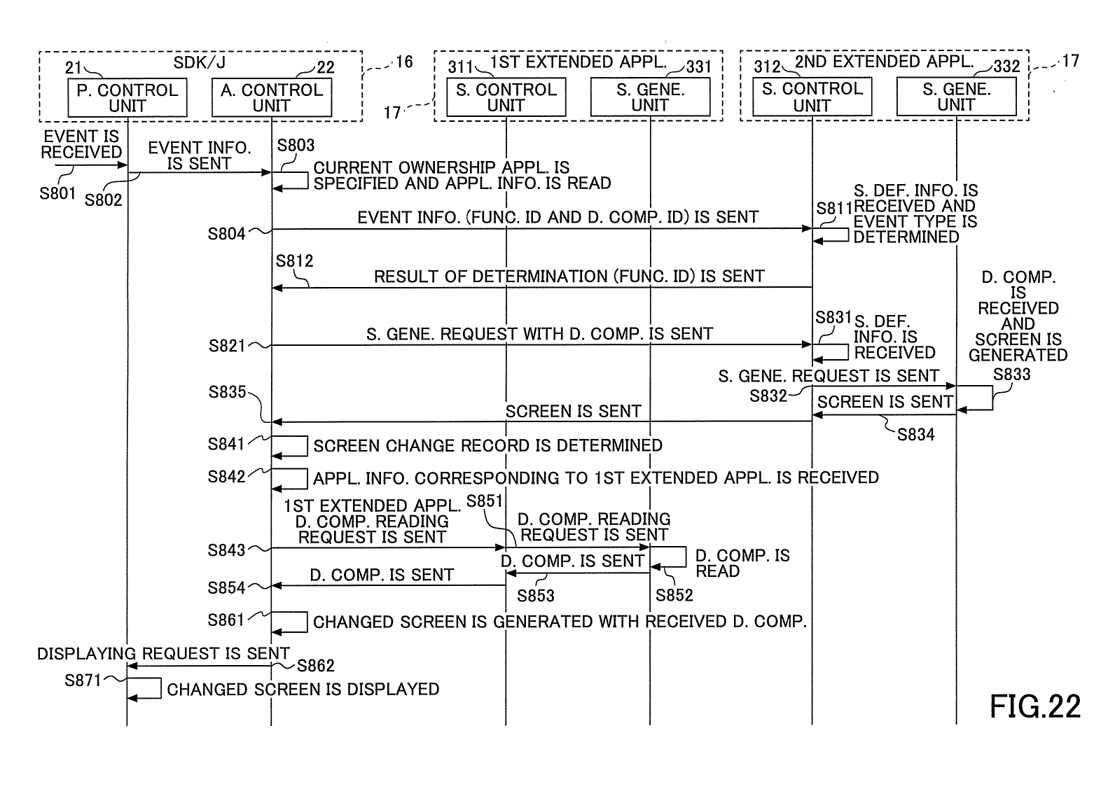

FIG. 22 is a sequence diagram for explaining a process of screen control of this embodiment. An example of a screen control process which performs the operation shown in FIG. 20 is shown in FIG. 22.

As shown in FIG. 22, when the panel control unit 21 receives an event by a screen manipulation (step S801), the event information is notified to the application control unit 22 (step S802). At this time, the panel control unit 21 associates the functional identification information, the selection component identification information, the display screen and the display component with the event information, and sends them to the application control unit 22.

The application control unit 22 specifies the extended application 17 which has the current ownership, when the event information is received (step S803). The application control unit 22 specifies the ownership application (the extended application to display the current screen) based on the ownership setting. In the case of FIG. 20, the application control unit 22 specifies the second extended application as the ownership application, and specifies the application information 23D2 of the second extended application based on the application information 23D acquired at the time of starting.

The application control unit 22 sends the event information to the second extended application that is the specified ownership application (step S804). At this time, the application control unit 22 sends the functional identification information of the received event information, the selection component identification information, etc. to the second extended application.

By the screen control unit 312, the second extended application acquires the screen definition information 32022 (definition information of a PrintFunc function) applicable to the functional identification information, and determines the event type (step S811). In the case of FIG. 20, the screen control unit 312 acquires the identification information of the CopyFunc function.

The screen control unit 312 answers to the application control unit 22 of the event-type determination requesting unit the acquired functional identification information as a result of the determination (step S812).

The application control unit 22 specifies the CopyFunc function of the second extended application corresponding to the screen change destination based on the functional identification information received as a result of determination of the screen change event. The application control unit 22 specifies the function of the extended application 17 which displays the current screen as the screen change destination, when only the functional identification information is received as a result of determination of the screen change event. In the case of FIG. 20, the application control unit 22 specifies the function (CopyFunc function) of the second extended application in the functional identification information as the screen change destination.

The application control unit 22 sends a screen generating request to the second extended application specified as the screen change destination (step S821). At this time, the application control unit 22 sends the functional identification information received as a result of the determination, the display component storage address information on application information 23D2, etc. to the second extended application. The application control unit 22 sends the parameter which requests addition of the return button and the function selection button (the selection component which can direct to change to another function (PrintFunc function) of the second extended application), to the second extended application. The application control unit 22 sends the screen base data to the second extended application.

By the screen control unit 312, the second extended application accesses the screen definition information storage unit 322, and acquires the corresponding screen definition information 32021 (definition information of the CopyFunc function) based on the functional identification information received at the time of the screen generating request (step S831). When the information is already acquired, the screen definition information 32021 temporarily stored on the memory may be specified. At this time, the screen control unit 312 checks existence of the returning definition (existence of the definition information of the return button) by accessing the screen definition information 32021 acquired or specified.

The screen control unit 312 sends a screen generating request to the screen generating unit 332 of the second extended application (step S832). At this time, the screen control unit 312 sends the screen definition information 32021, the screen base data, the display component storage address information received at the time of the screen generating request, etc. to the screen generating unit 332. The screen control unit 312 requests addition of the button to the screen generating unit 332 only when the existence of the returning definition is checked.

The screen generating unit 332 acquires an applicable display component (a functional screen composition display component and PrintFunc function selection components) from the display component storage unit 342. The screen generating unit 332 arranges the acquired display component on the screen according to the screen definition information 32D21, so that a screen (CopyFunc screen) is generated based on the screen base data (step S833). At this time, the screen generating unit 332 adds the return button and the function selection button to the generated screen according to the display component addition request. The screen generating unit 332 sends the generated screen to the screen control unit 312 (step S834).

The screen control unit 312 answers the generated screen received as a result of the screen generation to the application control unit 22 of the screen generating request source (step S835).

The application control unit 22 determines the log of the screen change (step S841). In the case of FIG. 20, the preceding screen is the PrintFunc screen W22, and the application control unit 22 determines that it is necessary to add the extended application selection button of the default ownership application (first extended application) to the change destination screen. Based on the application information 230 acquired at the time of starting, the application control unit 22 specifies the application information 2301 (the application information of the first extended application) applicable to the default ownership application (first extended application) (step S842).

The application control unit 22 sends a request of acquisition of a display component to the first extended application that is the default ownership application (step S843). At this time, the application control unit 22 sends the display component storage address information of the specified application information 2301 etc. to the first extended application.

The first extended application requests acquisition of the extended application selection component to the screen generating unit 331 by using the screen control unit 311 (step S851). At this time, the screen control unit 311 sends the display component storage address information received at the time of the acquisition request to the screen generating unit 331.

The screen generating unit 331 accesses the display component storage unit 341 and acquires the corresponding display component (function selection component of the first extended application) based on the display component storage address information received at the time of the acquisition request (step S852). The screen generating unit 331 sends the acquired extended application selection component to the screen control unit 311 (step S853).

The screen control unit 311 answers the extended application selection component received as the acquired result to the application control unit 22 of the display component acquisition request source (step S854).

The application control unit 22 arranges the acquired extended application selection component on the CopyFunc screen W21 generated by the second extended application, according to the screen definition information 32021 of the second extended application, and generates the screen of the screen change destination (step S861).

The application control unit 22 sends a screen displaying request to the panel control unit 21 (step S862). At this time, the application control unit 22 sends the data of the CopyFunc screen W21 (change destination screen) generated as the screen change destination in the above-described processing, to the panel control unit 21.

The panel control unit 21 displays the change destination screen received at the time of the screen displaying request, on the screen of the operation panel 120 (step S871). At this time, the panel control unit 21 sets the non-displaying of the PrintFunc screen W22 (functional screen) of the screen change source.

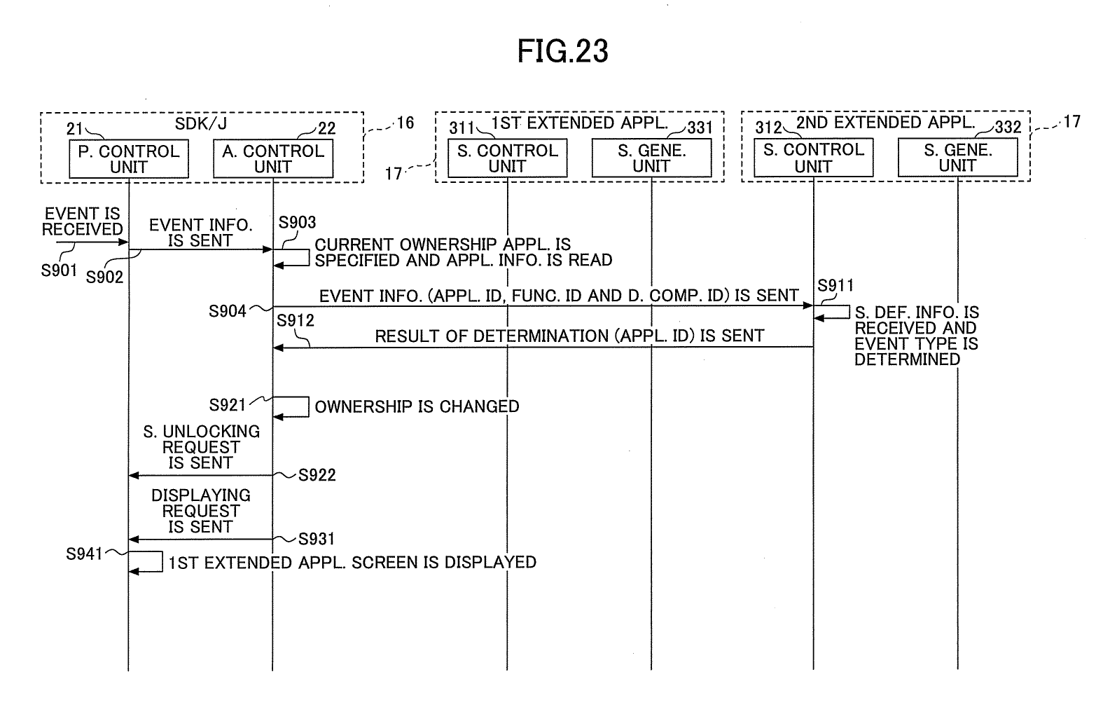

FIG. 23 is a sequence diagram for explaining a process of screen control of this embodiment.

An example of a screen control process which performs the operation shown in FIG. 20 is shown in FIG. 23. As shown in FIG. 23, when the panel control unit 21 receives an event by a screen manipulation (step S901), the event information is notified to the application control unit 22 (step S902). At this time, the panel control unit 21 associates the application identification information, the functional identification information, the selection component identification information, the display screen and the display component with the event information, and sends them to the application control unit 22.

When the event information is received, the application control unit 22 specifies the extended application 17 which has the current ownership (step S903). Based on the ownership setting, the application control unit 22 specifies the ownership application (the extended application to display the current screen). In the case of FIG. 20, the application control unit 22 specifies the second extended application as the ownership application and specifies the application information 23D2 of the second extended application based on the application information 23D acquired at the time of starting.

The application control unit 22 sends the event information to the second extended application that is the specified ownership application (step S904). At this time, the application control unit 22 sends the application identification information, the functional identification information, the selection component identification information, etc. of the received event information, to the second extended application.

By the screen control unit 312, the second extended application acquires the screen definition information 32D21 (definition information of the CopyFunc function) applicable to the functional identification information, and determines the event type (step S911). In the case of FIG. 20, the screen control unit 312 acquires the identification information of the identification information of the first extended application.

The screen control unit 311 answers to the application control unit 22 of the event-type determination requesting unit the acquired application identification information as a result of the determination (step S912).

The application control unit 22 changes the ownership into the extended application 17 (from the second extended application to the first extended application) of the screen change destination (step S921), and requests unlocking of the screen display to the panel control unit 21 (step S922). In the case of FIG. 20, the application identification information received as a result of the determination of the screen change event is not in agreement with the application identification information of the second extended application (ownership application) that displays the current screen, and the application control unit 22 determines that it is necessary to change the ownership into the first extended application in the received application identification information.

The application control unit 22 sends a request of screen displaying of the first extended application to the panel control unit 21 (step S931).

The panel control unit 21 displays the extended application screen W1 of the default ownership application, which has not been displayed, on the operation panel 120 (step S941). At this time, the panel control unit 21 sets the non-displaying state of the preceding screen W21, and locks the display screen.

Accordingly, the image processing device 100 of this embodiment is arranged so that, at the time of starting of the image processing device, the extended application 17 which is the default ownership application is caused to generate a starting screen, and the display component collected from another extended application 17 is arranged on the screen being generated, so that the starting screen is generated. In the image processing device 100 of this embodiment, the operational screen in which the plurality of functions of the extended application 17 can be selected at once can be displayed. Moreover, in the image processing device 100 of this embodiment, based on the screen change log, when performing the operation of a screen change between the functions of the extended application 17 after the device starting, the functional screen which enables the user to return to the extended application 17 as the default ownership application by one operation is generated. Thereby, according to the image processing device 100 of this embodiment, the number of operations needed at the time of a screen change between the functions of the extended application can be reduced.

As described in the foregoing, according to the image processing device 100 of this embodiment, at the time of starting of the image processing device, the application control unit 22 which controls the installed extended application 17 acquires the screen definition information 3201 and the extended application screen W1 from the first extended application that is the default ownership application. When the definition information of the extended application 17 (second extended application) other than the first extended application is included in the acquired screen definition information 32D1, the application control unit 22 acquires the second extended application and the extended application/function selection components from the second extended application based on the composition function of the application information 23D2 registered at the time of installation. The application control unit 22 generates a starting screen by arranging the acquired extended application/function selection components on the application screen W1 acquired previously. As a result, in the image processing device 100, the extended application screen W1 including the selection component of the second extended application is displayed as a starting screen.

Next, a second embodiment of the present disclosure will be described. In this embodiment, a screen control system, including an image processing device and an external device (or a screen management device), other than the image processing device, which manages the screen definition information, is arranged to carry out the functional cooperation.

In the following, only a difference between the second embodiment and the first embodiment will be described, and the elements in the second embodiment which are the same as corresponding elements in the first embodiment are designated by the same reference numerals, and a description thereof will be omitted.

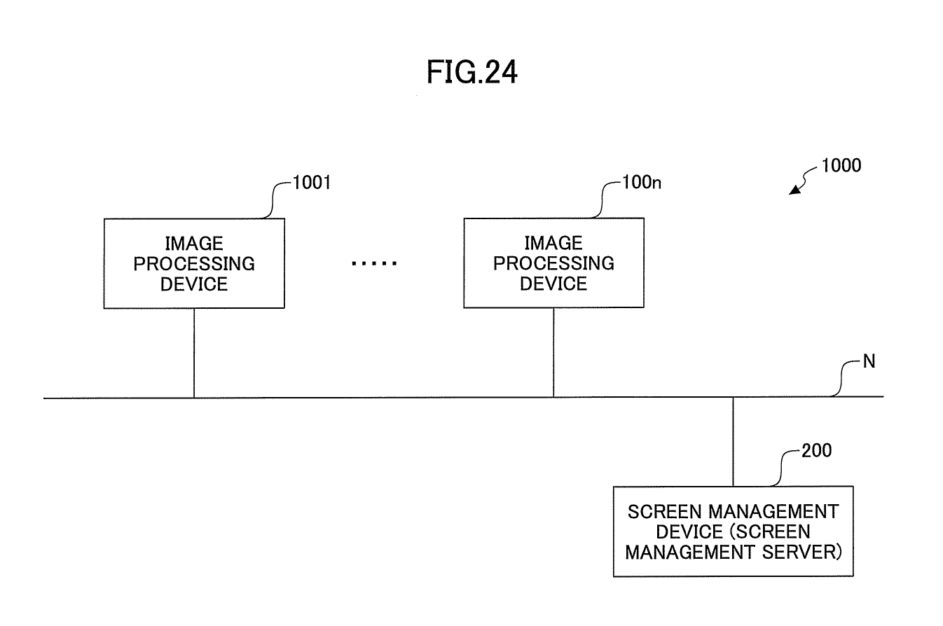

FIG. 24 is a diagram showing the composition of the screen control system 1000 of this embodiment. As shown in FIG. 24, in the system 1000, a plurality of image processing devices 1001-100n (each of which may be collectively called the image processing device 100) and a screen management device (screen management server) 200 are connected by a predetermined data communication path N (for example, LAN).

The image processing device 100 is a device which has image processing functions. The image processing functions may include, for example, document reading, printing, etc. On the other hand, the screen management device 200 is a device which has information processing functions to manage the screen definition information 32D of the extended application 17 installed in the image processing device 100. The information processing functions may include, for example, generation, editing, supplying, etc. of the screen definition information 32D (transmission to the image processing device).

As mentioned above, in the screen control system 1000 of this embodiment, the screen control service which performs batch management of the screen definition information 32D of the extended application 17 commonly installed in each of the image processing devices 100 is provided by the above-described system configuration. Thereby, the user does not need to manage the screen definition information 32D of the extended application 17 installed in each image processing device 100, and the load of management is reduced.

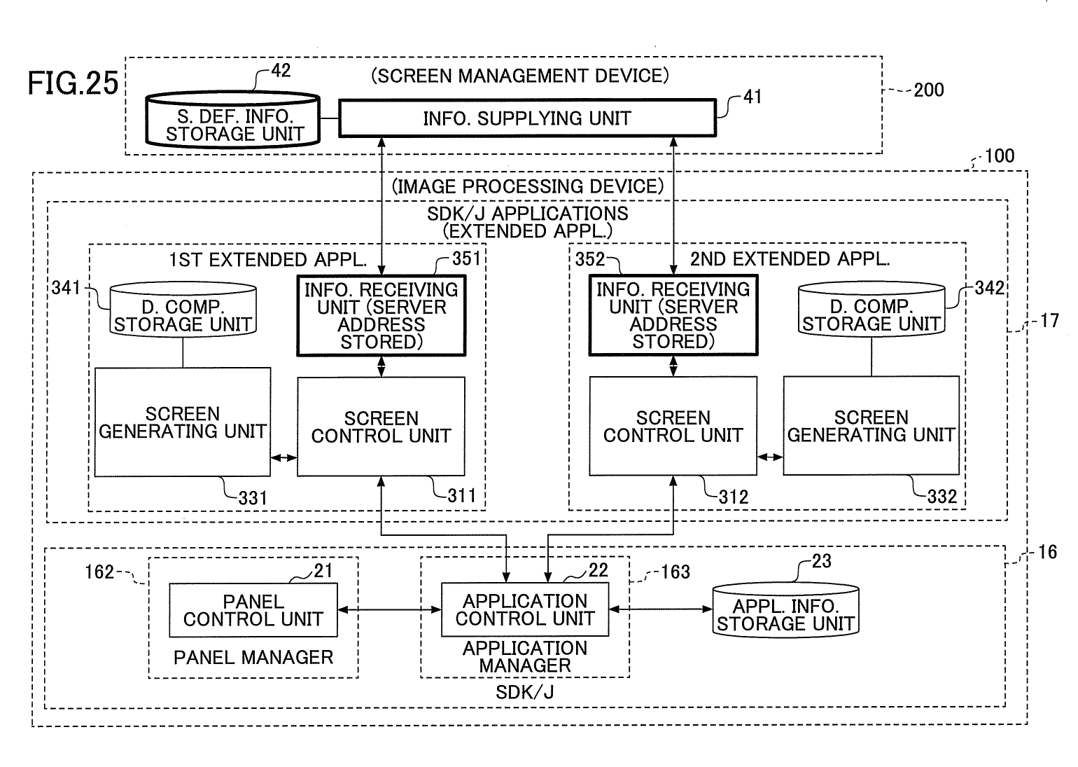

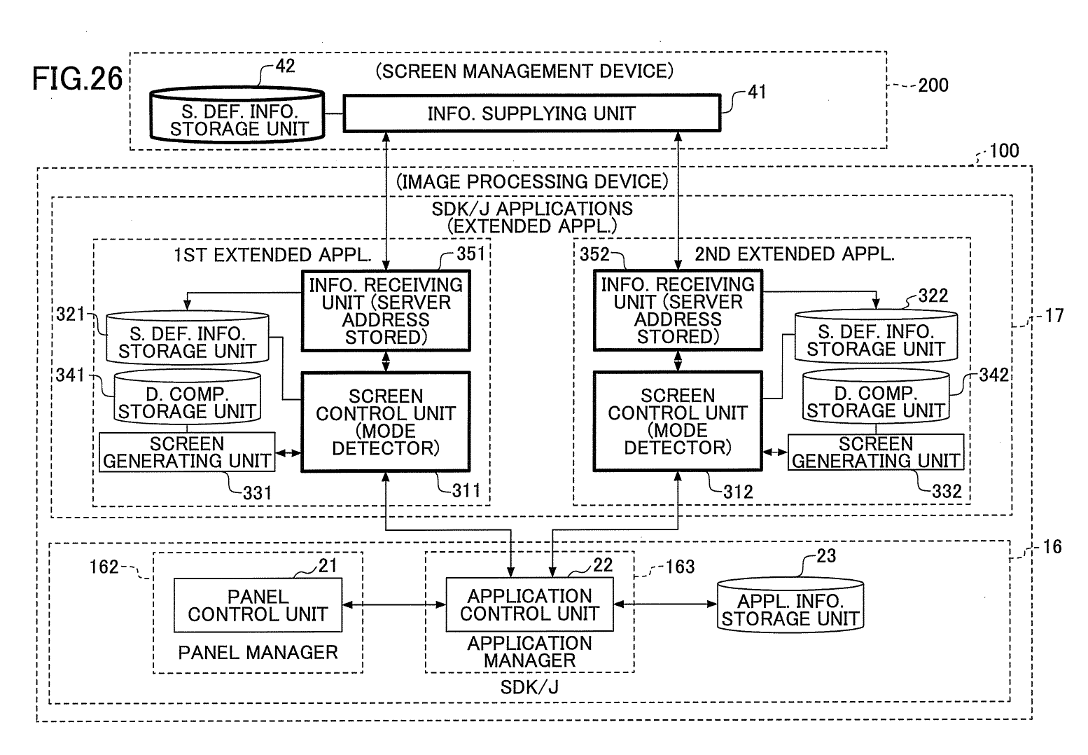

In the screen management system 1000 of this embodiment, the composition of the screen control function is provided as shown in FIGS. 25 and 26.

FIG. 25 is a diagram showing the composition of the screen control function of this embodiment. In the screen control function shown in FIG. 25, each extended application 17 of the image processing device 100 includes an information receiving unit 35 which acquires the screen definition information 32D from the screen management device 200. Namely, these function parts operate in the environment in which each extended application 17 operates. In the composition shown in FIG. 25, the first extended application and the second extended application include an information receiving unit 351 and an information receiving unit 352, respectively. When the function parts of the extended application 17 are collectively referred to, each of the information receiving unit 351 and 352 will be called the information receiving unit 35.

In the screen control function, the screen management device 200 includes an information supplying unit 41 and a screen definition information storage unit 42, which are configured to supply the screen definition information 32D to the image processing device 100. The functional cooperation between the information receiving unit 35 of the image processing device 100 and the information supplying unit 41 of the screen management device 200 is performed as follows.

First, the information receiving unit 35 requests acquisition of the screen definition information 32D to the information supplying unit 41 based on the application identification information (or the functional identification information) in response to the acquisition request from the screen control unit 31. For example, the screen control unit 31 sends a request of acquisition of the screen definition information 32D to the information receiving unit 35 when a screen generating request or an event-type determining request is received from the application control unit 22. At this time, the screen control unit 31 sends the application identification information (functional identification information) received from the application control unit 22, to the information receiving unit 35. When the acquisition request is received, the information receiving unit 35 sends an acquisition command in which the application identification information (or the functional identification information) is set up, to the screen management device 200 based on the network setting information (for example, IP address etc.) set up beforehand.

In the screen management device 200, the information supplying unit 41 accesses the screen definition information storage unit 42, and acquires the corresponding screen definition information 32D based on the application identification information (functional identification information) received at the time of reception of the acquisition command.

The information supplying unit 41 sends a response command in which the acquired information is set up, to the image processing device 100 which is the information requesting source. As a result, in the image processing device 100, the information receiving unit 35 sends the acquired screen definition information 32D to the screen control unit 31 of the acquisition requesting source.

The information receiving unit 35 may be arranged to temporarily store the acquired screen definition information 32D. In this case, the information receiving unit 35 may send an acquisition request to the screen management device 200 only when a request of acquisition of the non-stored screen definition information 32D is received. Such functional composition environment will be called the embedded mode.

In this embodiment, by the above-mentioned functional composition environment, the newest screen definition information 32D managed by the screen management device 200 is applicable to the extended application 17 installed in each of the image processing devices 100.

FIG. 26 is a diagram showing the composition of the screen control function of this embodiment. In the composition shown in FIG. 26, the functional composition environment is arranged so that the embedded mode and the server mode coexist. The embedded mode is the functional composition environment in which the screen management device 200 supplies the screen definition information 320 in response to an acquisition request from the image processing device 100 as mentioned above. On the other hand, the server mode is the functional composition environment in which the screen management device 200 supplies the screen definition information 32D dynamically at a predetermined timing (a prescribed interval or a predetermined time) to the image processing device 100. Thereby, in the image processing device 100 in the server mode, the screen definition information 32D received from the screen management device 200 is stored in the screen definition information storage unit 32 by the information receiving unit 35.

In the screen control function (the embedded and server mode coexisting environment) shown in FIG. 26, the following functional coordinated operations are performed between the information receiving unit 35 of the image processing device 100 and the information supplying unit 41 of the screen management device 200.

First, the screen control unit 31 performs mode detection. Based on the mode setting, the screen control unit 31 detects whether the mode in which the screen control function of the image processing device 100 is currently set is the embedded mode or the server mode. The timing of execution of the mode detection may be determined according to a predetermined schedule. The mode setting and the execution timing may be arbitrarily set up through the operation panel 120 by a user.

When it is detected that the currently set mode is the embedded mode, the screen control unit 31 sends an acquisition request to the information receiving unit 35, and acquires the specified screen definition information 32D from the information supplying unit 41 by using the information receiving unit 35.

On the other hand, when it is detected that the currently set mode is the server mode, the screen control unit 31 sends a request of checking of the update date of the screen definition information 320 stored in the screen management device 200, to the information receiving unit 35.

In response to the update date checking request from the screen control unit 31, the information receiving unit 35 sends a request of acquisition of the update date of the screen definition information 32D to the information supplying unit 41 based on the application identification information (or the functional identification information). When the update date checking request is received, the information receiving unit 35 sends an update date acquisition command in which the application identification information (or the functional identification information) is set up, to the screen management device 200 based on the network setting information.

In the screen management device 200, the information supplying unit 41 accesses the screen definition information storage unit 42, and acquires the update date of the applicable screen definition information 32D based on the application identification information (or the functional identification information) received at the time of command reception.

The information supplying unit 41 sends the response command in which the date of acquisition is set up to the image processing device 100 of the update date acquisition request source.

As a result, in the image processing device 100, the update date of the specified screen definition information 32D is acquired from the screen management device 200 by using the information receiving unit 35. The information receiving unit 35 accesses the screen definition information storage unit 32, and compares the update date of the specified screen definition information 32D with the update date that the screen definition information is acquired from the screen management device 200 based on the application identification information (or the functional identification information).

When the information supplying unit 35 determines from a result of the comparison that the data of the screen definition information 32D stored in the screen management device 200 is newer (when the update date acquired from the screen management device 200 is newer), the newest screen definition information 32D is acquired from the information supplying unit 41 of the screen management device 200 similar to the case of the embedded mode.

On the other hand, when the information supplying unit 35 determines that the data of the screen definition information 32D stored in the image processing device 100 is newer (when the update date acquired from the screen management device 200 is older), the screen definition information 32D is not acquired from the screen management device 200, but the screen definition information 32D stored in the image processing device 100 is acquired.

In this embodiment, by using the environment of the above-mentioned functional composition, the newest screen definition information 32D that is managed by the screen management device 200 is applicable to the extended applications 17 installed in each of the image processing devices 100. By switching one of the two modes to the other, the processing time and communication load of information acquisition can be also reduced.

As mentioned above, according to the screen control system 1000 of this embodiment, an operation of a screen change is performed by the functional cooperation with the image processing device 100 and the screen management device 200 among a plurality of functions in which extended application 17 which the operational screen which can be selected at once is displayed and is different after image processing device starting has a plurality of functions of the extended application 17, at the time of starting of the image processing device.

Hence, the screen control system 1000 of this embodiment can provide the same advantages as in the first embodiment. In the screen control system 1000 of this embodiment, batch management of the screen definition information 32D of the extended applications 17 installed in the plurality of image processing devices 100 is carried out by the screen management device 200, and the load of management of the application screens/functional screens by the user can be reduced.

The screen control function in the foregoing embodiments is carried out by the program which is written in the programming language suited to the operating environment (platform) and encoded to cause the processing unit (CPU) of the image processing device to execute the respective processes. The above-described program may be stored in the recording medium 114a which is readable by the image processing device 100 (computer). Therefore, the program read from the recording medium 114a (in which the program is stored beforehand) can be installed in the image processing device 100 through the external storage interface 114.

The image processing device 100 is provided with the network interface 113, and the above-described program may be downloaded and installed by using the data communication path, such as the Internet.

As described in the foregoing, in the image processing device, the display device, the screen control system, and the screen control method according to the present disclosure, the number of operations needed at the time of a screen change between the installed applications or between the functions of the applications can be reduced and the complexity of screen manipulations at the time of performing a process using the plural functions can be reduced.

The present disclosure is not limited to the specifically disclosed embodiments, and variations and modifications may be made without departing from the scope of the present disclosure.

The present application is based upon and claims the benefit of priority of Japanese patent application No. 2010-121748, filed on May 27, 2010, the contents of which are incorporated herein by reference in their entirety.

What is claimed is:

1. An image processing device in which a plurality of applications each having multiple functions can be installed, comprising:
a display device; and
an application control unit configured to control a displaying of an application screen or a functional screen on the display device and an operation of a screen change between the applications or between functions of the applications,
wherein, when screen definition information acquired from a first application and defining an application screen of the first application includes definition information of a second application corresponding to a screen change destination, the application control unit displays an application screen in which a display component for selecting a function of the second application is arranged in a predetermined position, on the display device as the application screen of the first application, and
wherein, when an input manipulation on the displayed application screen by a user is received, the application control unit specifies a function of the second application based on a result of determination of an event type of the received input manipulation and displays a functional screen of the specified function of the second application on the display device as a result of the operation of the screen change.

2. The image processing device according to claim 1, further comprising an application information storage unit to store application information, including composition function data which indicates a composition function of each of the installed applications of the image processing device, in a predetermined storage area,
wherein the application control unit requests the first application to generate an application screen by using application identification information of the first application, and acquires, from the first application, the screen definition information, defining the application screen of the application, and the generated application screen, and
wherein, when the definition information of the second application corresponding to the screen change destination is included in the acquired screen definition information, the application control unit acquires, from the second application, a display component for selecting a function of the second application, based on the composition function data of the second application included in the application information stored by the application information storage unit, and generates an application screen of the first application in which the display component is arranged in the predetermined position, to display the application screen of the first application on the display device.

3. The image processing device according to claim 1, wherein the application control unit requests the first application to determine an event type based on event information received from a user, and acquires, from the first application, functional identification information of a function of the second application of the screen change destination selected by the user, as a result of the determination, and
wherein the application control unit requests the second application to generate an application functional screen of the second application based on the acquired functional identification information, acquires, from the second application, the functional screen of the second application, and displays the functional screen on the display device.

4. The image processing device according to claim 3, wherein the application control unit sets the non-displaying of the application screen of the first application when displaying the functional screen of the second application.

5. The image processing device according to claim 1, wherein the first application comprises:
a screen definition information storage unit to store the screen definition information in a predetermined storage area;
a display component storage unit to store the display component in a predetermined storage area;
a screen control unit to control generation of the application screen; and
a screen generating unit to generate the application screen or the functional screen,
wherein the screen control unit acquires, when a screen generating request from the application control unit is received, corresponding screen definition information from the screen definition information storage unit based on application identification information and functional identification information received with the screen generating request,
wherein the screen generating unit acquires, when a screen generating request from the screen control unit is received, a corresponding display component from the display component storage unit based on display component storage address information received with the screen generating request, and generates the application screen or the functional screen in which the display component is arranged based on the received screen definition information.

6. The image processing device according to claim 5, wherein, when an event determining request from the application control unit is received, the screen control unit accesses the screen definition information based on selected component identification information which identifies a selected display component contained in event information received with the event determining request, determines an event type from event-type information corresponding to the selected display component, and sends the application identification information and the functional identification information of the second application to the application control unit as a result of the determination.

7. The image processing device according to claim 5, wherein, when performing an operation of a screen change between the applications based on application identification information of the second application received from the screen control unit as a result of the determination of the event type, the application control unit changes a setting of an ownership of displaying a screen on the display device from the first application to the second application.

8. The image processing device according to claim 1, wherein, when requesting the second application to generate the functional screen, the application control unit requests the second application to arrange a display component for selecting the second application corresponding to the specified function on the functional screen, and
wherein, when the display component for selecting the second application on the functional screen is depressed by a user, the application control unit sets the non-displaying of the functional screen on the display device and displays an application screen of the selected application on the display device.

9. The image processing device according to claim 1, wherein, when requesting the second application to generate the functional screen, the application control unit requests the second application to arrange a display component for selecting a default application on the functional screen, and
wherein, when the display component for selecting the default application on the functional screen is depressed by a user, the application control unit sets the non-displaying of the functional screen on the display device and displays an application screen of the selected default application on the display device.

10. The image processing device according to claim 1, wherein, when displaying a starting screen of the image processing device, the application control unit requests each of the applications to generate the application screen based on the application information, acquires the application screen of each of the applications, and stores the application screen of each of the applications in a predetermined storage area,
wherein, when performing an operation of a screen change between the applications, the application control unit acquires a corresponding application screen from the predetermined storage area, and displays the acquired application screen on the display device, and
wherein, when performing an operation of a screen change between the functions of the applications, the application control unit requests a corresponding application to generate a functional screen of the corresponding application, and displays the functional screen, acquired from the corresponding application, on the display device.

11. A display device which is provided in the image processing device of claim 1, wherein the functional screen of the specified function of the second application is displayed on the display device by the application control unit of the image processing device.

12. A screen control system including a screen management device and the image processing device of claim 1 which are connected through a predetermined data communication path,
wherein the screen management device stores screen definition information defining an application screen of each of the applications, in a predetermined storage area, and
wherein the image processing device comprises an information receiving unit to acquire the screen definition information from the screen management device.

13. The screen control system according to claim 12, wherein, when the screen definition information stored in the screen management device is newer than the screen definition information stored in the image processing device, the information receiving unit acquires the screen definition information from the screen management device.

14. A screen control system including an image processing device and a screen management device which are connected through a predetermined data communication path, a plurality of applications each having multiple functions being installed in the image processing device, and the screen management device storing screen definition information defining an application screen of each of the applications, in a predetermined storage area,
the image processing device including a display device and an application control unit configured to control a displaying of an application screen or a functional screen on the display device and an operation of a screen change between the applications or between functions of the applications,
the screen management device including an information supplying unit to supply the screen definition information to the image processing device,
wherein, when screen definition information defining an application screen of a first application and supplied by the information supplying unit includes definition information of a second application corresponding to a screen change destination, the application control unit displays an application screen in which a display component for selecting a function of the second application is arranged in a predetermined position, on the display device as the application screen of the first application, and
wherein, when an input manipulation on the displayed application screen by a user is received, the application control unit specifies a function of the second application based on a result of determination of an event type of the received input manipulation and displays a functional screen of the specified function of the second application on the display device as a result of the operation of the screen change.

15. A screen control method for use in an image processing device in which a plurality of applications each having multiple functions can be installed, the image processing device including a display device and an application control unit configured to control a displaying of an application screen or a functional screen on the display device and an operation of a screen change between the applications or between functions of the applications, the screen control method comprising:
displaying, by the application control unit, when screen definition information acquired from a first application and defining an application screen of the first application includes definition information of a second application corresponding to a screen change destination, an application screen in which a display component for selecting a function of the second application is arranged in a predetermined position, on the display device as the application screen of the first application;
specifying, by the application control unit, when an input manipulation on the displayed application screen by a user is received, a function of the second application based on a result of determination of an event type of the received input manipulation; and
displaying, by the application control unit, a functional screen of the specified function of the second application on the display device as a result of the operation of the screen change.
